(19) United States
(12) Patent Application Publication
(10) Pub. No.: US 2026/0279866 A1
(43) Pub. Date: Sep. 17, 2026

(54) PHOTO-BIO-ELECTROCHEMICAL CELL

(71) Applicant: TECHNION RESEARCH & DEVELOPMENT FOUNDATION LIMITED, Haifa (IL)

(72) Inventors: Omer YEHEZKELI, Haifa (IL); Mor SHEMESH, Haifa (IL); Yifat COHEN, Haifa (IL); Roy COHEN, Haifa (IL)

(73) Assignee: TECHNION RESEARCH & DEVELOPMENT FOUNDATION LIMITED, Haifa (IL)

(21) Appl. No.: 19/166,811

(22) PCT Filed: May 22, 2024
(86) PCT No.: PCT/IL2024/050498

§ 371 Date: Sep. 18, 2025

Related U.S. Application Data
(60) Provisional application No. 63/504,013, filed on May 24, 2023.

(51) Int. Cl. H01M 8/16; H01M 4/90

(52) U.S. Cl. CPC H01M 8/16; H01M 4/9016

(57) ABSTRACT

The invention generally concerns photo-electrochemical cells for generating electric currents from organic materials.

### TECHNOLOGICAL FIELD

The invention generally contemplates a photo-bio-electrochemical cell and uses thereof.

### BACKGROUND OF THE INVENTION

A continued increase in global energy demands along with fossil depletion and environmental pollution threats have led to a growing interest in renewable energy alternatives. Biomass is a highly abundant material and has great potential to be exploited as a fuel alternative. However, while, generally, biomass can be directly consumed as a combustion fuel, the low efficiency and the release of harmful gases pose significant disadvantages.

Cellulose, which constitutes a major part of a typical biomass, is a densely packed polysaccharide material comprised of repeatable glucose molecules. In its crystalline form, cellulose is very stable; however, natural enzymatic processes can facilitate its degradation into glucose monomers. Enzymatic breakdown of cellulose is carried out by the enzymatic cellulase complex, which works synergistically to achieve complete cellulose hydrolysis. The cellulase complex comprises several enzymes which can break down the β (1→4) glycosidic bonds positioned at different sites in the cellulose polymer, reaching full degradation to glucose or cellobiose. In nature, cellulase complex enzymes are secreted by bacteria or fungi for cellulose degradation. The products obtained are absorbed into the bacteria cells and are utilized as chemical energy.

Traditional fuel cells can be utilized for glucose oxidation; however, standard fuel cells require high overpotential and thus high fabrication costs, generate low power output, use expensive rare metals, and suffer from passivation. Enzymatic biofuel cells (EBFC) are fuel cell devices that utilize enzymes as catalysts. These devices can be constructed by electronically coupling enzymes with electrodes using direct or mediated electron transfer processes. Cellulose-based biomass is cheap, abundant, and non-toxic, therefore has been widely explored as an alternative energy source.

Shi et al. [1] have presented an enzymatic fuel cell for power generation from corn stover. The enzymatic fuel cell comprising fifteen enzymes used for the complete oxidation of glucose and xylose, NAD+ and ATP, yielded a maximal power output of 500 μW/cm².

Cheng et al. [2] have conjugated a glucose dehydrogenase (GDH) based anode with a laccase based a cathode, in the presence of NAD+ and cellulase complex in the cell solution for energy generation while carboxymethyl-cellulose (CMC) served as an energy source. The EBFC yielded a maximum power output of 128 μW/cm² under ambient air at room temperature.

Recently the inventors of the technology disclosed herein have developed a biofuel cell (BFC) device for the direct conversion of cellulose to electrical energy. A flavin dehydrogenase-based anode and a bilirubin oxidase (BOD) based cathode were conjugated and further utilized to generate energy in the presence of cellulose and cellulase complex. The cell power output reached 300 μW/cm² and 600 μW/cm² under air and oxygen-saturated atmosphere, respectively. Unlike the BFCs used for cellulose-to-energy conversion described previously, this one-pot enzymatic biofuel cell required only oxygen and cellulose for its operation. Although this approach has great promise, the operation lifetime is limited, mainly due to the bio-anode instability. Furthermore, minimizing the required overpotential for glucose oxidation should maximize the performance. For that, light-induced reactions can be coupled, using a photoanode that improves the electrical power output [3].

Photo-electrochemical cells (PECs) gain energy by the light-induced reaction. Since first introduced by Honda and Fujishima in 1972 [4], many different PEC configurations have been developed with improved efficiencies. The 2.4 eV bandgap BiVO₄ semiconductor can be activated using visible light irradiation to enable a water oxidation reaction. In addition to up to 60% quantum efficiency in water-splitting reactions, BiVO₄-based photoanodes have low fabrication costs, high availability, good stability, and low toxicity. Hence, BiVO₄-based PECs have been commonly used in PECs configurations due to a slow rate of hole transport towards the electrode surface. Therefore, the addition of oxygen evolving catalyst (OEC) in a second co-catalyst layer is usually required for enhanced activity.

### BACKGROUND PUBLICATIONS

[1] P. Shi, R. Wu, J. Wang, C. Ma, Z. Li and Z. Zhu, Bioelectrochemistry, 2022, 144, 108008.
[2] H. Cheng, Q. Qian, X. Wang, P. Yu and L. Mao, Electrochimica Acta, 2012, 82, 203-207.
[3] N. S. Herzallh, Y. Cohen, R. Cohen, O. Chmelnik, Y. Shoham and O. Yehezkeli, Sustainable Energy Fuels, 2021, 5, 4580-4586
[4] A. Fujishima and K. Honda, Nature, 1972, 238, 37-38.

### General Description

Against the teachings of the prior art, the inventors of the technology disclosed herein have developed a photo-bio-electrochemical cell (PBEC) device that directly utilizes organic waste, such as cellulose or any waste containing cellulose and/or other carbohydrates, as fuel for generating electrical energy, substantially suppressing water oxidation processes. In an exemplary biotic-abiotic interfaced configuration, an enzyme was utilized for converting a cellulosic material into monomeric glucose molecules. The released glucose was then oxidized on a photoanode (e.g., a BiVO₄ photoanode), in a one pot reaction, to generate photocurrents. Uniquely, the photocurrents were generated in absence of competing water oxidation processes which were typically observed when the photoanodes used were made of such materials as BiVO₄. Suppressing water oxidation negated the competing reaction, and provided a stable and enhanced performance.

Eliminating oxygen generation further laid the ground for the utilization of the photoanode in conjugation with anaerobic bacteria cells. The developed photoanodes facilitated the conversion of carbohydrates (glucose or cellobiose) as well as other organic materials such as lactate, directly to ca. 1 mA/cm² photocurrents. Based on the results presented herein, an increase in the measured current could be achieved with as low a concentration of the organic material, e.g., cellulose, as 300 nM.

The photo-driven oxidation products were investigated using H¹-NMR spectroscopy. The results provide an interesting oxidation path of the saccharides into small molecules, e.g., acetic acid, that could be further used for industrial processes. Lastly, the developed photoanode was coupled with a bilirubin oxidase-based bio-cathode to construct a bias-free photo-biofuel cell. The Accellerase 1500 mixture was used as an exemplary enzymatic cellulase complex to hydrolyse cellulose into glucose which, in turn, was oxidized by the BiVO₄/CoP photoanode. The presented photo-bio-electrochemical cell exhibited high performance, reaching above 1V of open circuit voltage (OCV), and 1 mA/cm² with great stability.

The photo-electrochemical cell of the invention allows for a pollution-free generation of electrical power under ambient conditions while only cellulose, lactate, glucose or other organic materials, oxygen, and light are required for its operation. The oxygen reaction suppression allows a new path for selective homogeneous catalyst-free oxidation of organic molecules in high efficiency which can be further integrated with bioreactors/microbial fuel cells to maximize the biotic abiotic synergetic effect.

Thus, in a first aspect of the technology there is provided a photoanode for a photo-electrochemical cell (or system), the photoanode comprising or consisting an n-type material having a band gap below 2.5 eV and oxidation potential of at least +1V vs. Ag/AgCl (when irradiated by visible light).

Further provided is a photoanode comprising or consisting an n-type material having a band gap below 2.5 eV and oxidation potential of at least +1V vs. Ag/AgCl for use in a process for converting organic material (or waste) into electrical energy, wherein the process comprises irradiating the organic material (or the system including the electrodes) by visible light under conditions permitting oxidation of the organic material, without causing water oxidation.

In some embodiments, the organic material comprises at least 300 nM cellulose. The cellulose may constitute a substantive component of the organic material. The amount of the cellulose may be at least 300 nM, but may also be as high as at least 10, 20, 30, 40, 50, 60% or more of the organic material or waste.

In some embodiments, the oxidation comprises oxidizing a carbohydrate, e.g., glucose, present in the organic material or generated by decomposition of cellulose present in the organic material to generate photocurrents, under conditions of low applied potentials, e.g., −0.5V to 0V vs. Ag/AgCl.

The invention further provides a photoanode for use in a process of water purification or in a process for decomposing organic matter present in a water feed, wherein the photoanode comprising or consisting an n-type material having a band gap below 2.5 eV and oxidation potential of an organic matter of at least +1V vs. Ag/AgCl under light irradiation, and wherein the photoanode suppresses or does not induce water oxidation reactions.

The “photoanode” of the invention is a working electrode of a photo-electrochemical cell of the invention, which, upon exposure to visible light, converts light energy into electrical energy. As stated herein, the photoanode is an n-type material or comprises an n-type material having a band gap below 2.5 eV and an oxidation potential that is at least +1V vs. Ag/AgCl. The n-type material may be selected from such materials known in the art. The material may be formed as an integral part of anode or may be provided as an active coating or a film on a surface of the anode. Non-limiting examples of such n-type materials include BiVO₄, Fe₂O₃/Fe₃O₄, Fe₃O₄, Fe₂O₃, Cu₂O, CuO₂, CuO, CdS, CdSe, CdTe, and CₓN_{y} (wherein each of x and y may be between 1 and 4, such as C₃N₄).

In some embodiments, the n-type material is BiVO₄, Fe₂O₃/Fe₃O₄, Fe₃O₄, Fe₂O₃, Cu₂O, CuO₂, CuO, CdS, CdSe, CdTe, or CₓN_{y} (wherein each of x and y may be between 1 and 4, such as C₃N₄), wherein the material is optionally, but not necessarily, provided with an active coating (of a material such as CoP or NiP or FeP or NiOₓ).

In some embodiments, the photoanode is a BiVO₄ electrode.

In some embodiments, the photoanode is a BiVO₄ electrode coated with a layer of CoP or NiP or FeP or NiOₓ. The thickness of the layer may be above 400 nm, or between 400 and 600 nm. At times, the thickness of the BiVO₄ and the layer, combined, may be above 400 nm, or between 400 and 600 nm

In some embodiments, the photoanode is a CdS coated with a NiOₓ coating (CdS/NiOₓ).

Thus, the invention further provides a BiVO₄-based photoanode for use in a system or a process of the invention, as defined herein.

The invention further provides a BiVO₄-based photoanode provided with a layer of CoP (designated BiVO₄/CoP) having a total thickness above 400 nm, or between 400 and 600 nm. This layer may be generated by electrodeposition of cobalt as described using a charge of 0.38C

Also provided is a photoactive film for a photoanode, the film comprising a BiVO₄ material coated with a layer of CoP, with a thickness above 400 nm, or between 400 and 600 nm.

In accordance with the invention, further provided is a BiVO₄/CoP photoanode for use in a process for generating electrical energy, wherein the process comprises irradiating organic material (or a system comprising the material and the electrode) by visible light under conditions permitting oxidation of the organic material, without causing water oxidation (or without generating oxygen).

The invention further provides a photo-electrochemical cell or system implementing a photoanode formed of or comprising an n-type material having a band gap below 2.5 eV and oxidation potential of at least +1V vs. Ag/AgCl (when irradiated by visible light).

In some embodiments, the photoanode is of a material selected as above. In some embodiments, the photoanode is a BiVO₄-based photoanode. In some embodiments, the photoanode is a BiVO₄-based photoanode provided with a layer of CoP, whereby the BiVO₄/CoP or the CoP layer having a thickness above 400 nm, or between 400 and 600 nm.

The photocathode is a p-type material as known in the art. It may be formed of or may comprise a material capable of reducing oxygen. Such a material may be selected from p-type materials such as NiO, NiO/CdS, NiO/CdTe, NiO/CdSe, CuFeO₂/CuO, and CuₓO_{y} (wherein each of x and y may be between 1 and 4).

In some embodiments, the photo-electrochemical cell or system comprises an electrode assembly comprising a BiVO₄/CoP photoanode and a cathode formed of or comprising a material selected from NiO, NiO/CdS, NiO/CdTe, NiO/CdSe, CuFeO₂/CuO, and CuₓO_{y} (wherein each of x and y may be between 1 and 4).

System and processes of the invention may be implemented in a wide variety of technologies for generating energy or for removal of organic materials or pollutants from a water-based feed. Such technologies may include water purification, wastewater treatment, removal of polymeric and biopolymeric pollutants and others. Generally, a water feed or an aqueous medium containing the organic material may be a pool or a reservoir of such waters or a flow of such waters, or a reactor cell, wherein an electrode assembly comprising a photoanode of the invention is continuously exposed to visible light (or irradiated by visible light) and the electrode assembly is immersed in the organic material or medium.

To initiate decomposition of the organic materials, the aqueous medium comprising the organic materials may be treated with one or more enzymatic material or enzyme-producing anaerobic bacteria. The enzymes (and thus the bacteria selected to generate same) are selected to be capable of digesting or decomposing the organic material, converting the organic material into simple compounds that can be oxidized on the photoanode. The enzymes or enzyme-producing bacteria may be selected, inter alia, based on the composition of the organic matter and used for implementing a continuous water purification process. The enzymes may be selected amongst lipases, amylases, cellulases, cellobiohydrolases, beta-glucosidases, lactases, hydrolases, lyases, ligases, PETase and others. These and other enzymes may be generated by bacteria such as Clostridium, E. Coli, Bacillus, Thermoacetica and others.

In some embodiments, the bacterium generating or producing enzyme is Clostridium Thermocellum.

Without wishing to be bound by theory, the selected bacterium expresses an extracellular multienzyme complex—the cellulosome, which comprises of 20 or more different enzymes which allow the lignocellulose degradation. Among the cellulosome enzymes are cellulases, esterases, glucosidases and hemicellulases. The cellulosome enzymes degrade the cellulose to cellodextrins (short glucose-based polymers holding 1,4 beta bonds, e.g. cellobiose), which are then transferred into the bacteria cell via transporter proteins. Inside the cell, these cellodextrins are further degraded to glucose-1-phosphate and glucose which is utilized as a substrate for glycolysis. In addition, the bacterium can utilize the generated cellodextrins to generate ethanol which can be further utilized as fuel.

The water medium or water feed may comprise organic materials of various sources and compositions. The organic material may be any natural or synthetic organic material, a pollutant, a toxic material, a polymeric material, a decomposed organic material, or any organic material, which may be soluble or insoluble in the water medium, and which may be present in any amount. The organic material may be a biomass material comprising materials such as paper, wood waste, and other sources of carbon, such as carbohydrates. The organic material may be similarly selected amongst carbohydrates, lipids, proteins, polymers, and others.

In some embodiments, the organic material is a material comprising a carbohydrate, or a cellulosic material. In some embodiments, the organic material comprises at least 300 nM of cellulose. In some embodiments, the organic material is cellulose.

In some embodiments, the organic material may be selected from paper, cardboard, wood, textile, agricultural residue, herbaceous material, municipal solid waste, pulp and paper mill residue, and others.

In some embodiments, the organic material comprises a cellulosic material such as cellulose, oxidized cellulose, hemicellulose, lignocellulose, etc, or any material comprising cellulose, such as paper, cardboard, wood, textile, agricultural residue, herbaceous material, municipal solid waste, pulp and paper mill residue, and others

In some embodiments of a photo-electrochemical cell or system of the invention, the photoanode formed of or comprising an n-type material having a band gap below 2.5 eV and oxidation potential of at least +1V vs. Ag/AgCl (when irradiated by visible light) is provided in a cellulose-containing water medium comprising an enzyme or an anaerobic bacteria capable of producing the enzyme, under conditions permitting enzymatic conversion of the cellulose in said water medium to glucose and oxidation of the glucose on the photoanode to generate photocurrents, with suppression of water oxidation.

In some embodiments, the enzyme is selected as defined hereinabove, e.g., amongst lipases, amylases, cellulases, lactases, hydrolases, lyases, ligases, PETase and others.

While the photoanode of the invention enables efficient and continuous oxidation of organic materials, water oxidation is substantially suppressed. The suppression of water oxidation is revealed as one of the surprising features of the present technology. The significant importance resides first in the suppression of competitive reactions, i.e., water oxidation, which dramatically improves efficiency of substrate oxidation, e.g., cellulose degradation products such as glucose, lactate and short soluble polymers. Second, the suppression of water oxidation reactions minimizes the concentration of oxygen in the cell. In such oxygen-free conditions, the photoanode may be suitable for anaerobic PBEC activation, due to the fact that most of the degrading bacteria operate under anerobic conditions.

The term “substantially suppressed”, or “without substantially oxidizing water”, or any similar expression or any lingual variation thereof, encompasses suppression of water oxidation reaction to a degree that is below a detection level using an electrochemical measurement such as cyclic voltammetry, NMR spectroscopy, GC-TCD and others. Typically, water oxidation reactions or oxygen gas evolution are minimized to undetectable levels and may thus be assumed to be non-existent. This suppression has been observed over long period of time.

The invention further provides a photo-bio-electrochemical cell (PBEC) for generating photocurrents, while substantially suppressing water oxidation reactions or processes (and consequently suppression oxygen evolution), the cell being configured to hold an aqueous medium, cellulose and at least one enzyme or enzyme-producing bacteria, and comprises an electrode assembly including a photoanode and a photocathode, wherein the photoanode is or comprises an n-type material having a band gap below 2.5 eV and oxidation potential for oxidizing the organic material that is at least +1V vs. Ag/AgCl under light irradiation.

Further provided is a photo-electrochemical cell for generating photocurrents from organic material present in an aqueous medium (i.e., suspended, dispersed, solubilized or generally carried by the medium), without substantially oxidizing water (or generating oxygen), the cell being configured to hold an aqueous medium comprising a cellulosic material and an enzyme or an anaerobic bacterium selected to produce said enzyme, the cell being provided with an electrode assembly comprising a photoanode being or comprising an n-type material having a band gap below 2.5 eV and an oxidation potential for oxidizing the cellulosic material that is at least +1V vs. Ag/AgCl, and wherein the photoanode is positioned to be exposed to solar radiation.

The invention also provides a photo-electrochemical cell configured to hold an aqueous medium comprising a cellulosic material and an enzyme or an anaerobic bacterium selected to produce said enzyme, the cell being provided with an electrode assembly comprising a photoanode formed of an n-type material having a band gap below 2.5 eV and an oxidation potential for oxidizing the cellulosic material that is at least +1V vs. Ag/AgCl, and wherein the photoanode is positioned to be exposed to solar (or light) radiation.

Also provided is a photo-electrochemical cell or system implementing a photoanode formed of or comprising an n-type material having a band gap below 2.5 eV and an oxidation potential of at least +1V vs. Ag/AgCl, when exposed to visible light irradiation; the n-type material being provided with an active coating and configured for generating photocurrents by oxidation of an organic material provided in an aqueous medium, without generating oxygen.

In some embodiments, the photo-electrochemical cell is configured to hold an aqueous medium comprising cellulose and an enzyme capable of degrading said cellulose or an anaerobic bacterium capable of producing said enzyme, the cell being provided with an electrode assembly comprising a BiVO₄/CoP photoanode configured to be positioned in said aqueous medium and exposed to solar (or visible light) radiation.

In some embodiments, the cells of the invention may comprise a filter for preventing passivation of the photoanode by the bacterium or enzymes present in the aqueous medium. In some embodiments, the filter is a polyethersulfone (PES) filter.

As used herein, the photocurrents generated by systems and processes of the invention are as known in the art—electric current that is generated through the photosensitive photoanode, upon exposure to light.

The invention further provides a process for generating photocurrents from organic material provided in an aqueous medium, the process comprising contacting the aqueous medium comprising the organic material and an enzyme or anaerobic bacteria producing said enzyme (such as Clostridium Thermocellum), in a system including an electrode assembly comprising a photoanode of an n-type material having a band gap below 2.5 eV and an oxidation potential of at least +1V vs. Ag/AgCl, under conditions suitable for causing enzymatic decomposition of the organic material in said aqueous medium and oxidation of the decomposed material on the photoanode to generate photocurrents.

In some embodiments, the organic material comprises cellulose. In some embodiments, the aqueous medium comprises at least 300 nM of cellulose.

In some embodiments, the enzymatic decomposition of cellulose provides glucose, being the material oxidized on the photoanode.

In some embodiments, the photoanode is as defined herein. In some embodiments, the photoanode is a BiVO₄/CoP photoanode.

Also provided is a process for generating photocurrents, the process comprising treating an aqueous medium comprising at least 300 nM cellulose and a cellulase enzyme or Clostridium Thermocellum, in a system including a BiVO₄/CoP photoanode, under light and applied potentials of between −0.5V and 0V vs. Ag/AgCl for causing decomposition of the cellulose in said aqueous medium and oxidation of the decomposed material on the photoanode to generate the photocurrents.

The conditions suitable for oxidizing the organic material and for carrying out the photo-electrochemical reactions involved in converting the organic material to photocurrents include one or more of the following:
an aqueous ionic medium, e.g., a buffer, at a pH of between 7.1 and 7.6, or a pH of e.g., 7.3, wherein the buffer is optionally a phosphate buffer, e.g., 0.2M buffer;
a temperature of between room temperature (23-33° C.) and 60° C.;
exposure to solar radiation, i.e., sun light or generally illumination by a light of a wavelength in the visible light region between 400 and 780 nm;
presence of an anerobic bacterium, e.g., Clostridium Thermocellum in O.D of at least 0.9, or between 0.9 and 3;
optionally under mixing of the aqueous medium at a rate of about 200 rpm; or optionally where the aqueous medium is flown; and
optionally an oxygen free atmosphere, wherein the oxygen concentration is below 2 ppm.

The aqueous solution or medium used in any of the photo-electrochemical cells of the invention typically comprises free ions which may be present in the medium or may be added to obtain a buffered solution of a pH between 7.1 and 7.6, or a pH of 7.3. In some cases, the buffered solution is or is treated with a buffer such as a phosphate buffer.

In some embodiments, the photoanode is a BiVO₄/CoP photoanode, and wherein the aqueous medium containing the organic material, e.g., cellulose, is maintained at a pH between pH 7.1 and 7.6, optionally in the presence of a phosphate buffer, e.g., 0.2M phosphate buffer.

In some embodiments, a process of the invention is directed at electrochemically purifying water (e.g., clearing water of organic matter), the process comprising:
providing a water feed into an electrochemical cell of the invention, e.g., configured as a water purification device;
controlling pH of the feed water; and
applying an electric voltage on the electrochemical cell photoanode to produce a purified water stream having a diminished level of organic matter.

Further provided is a process for generating energy, the process comprising:
providing a water feed into an electrochemical cell of the invention, e.g., configured as a water purification device;
controlling pH of the feed water and permitting decomposition of an organic matter present in the feed water in presence of enzymes; and
applying an electric voltage on the electrochemical cell photoanode to produce energy (i.e., generating currents in response to irradiance of the photoanode).

As used herein, the pH of the system or the process may be controlled by continuously or periodically measuring the pH of the water to ensure a pH between 7.1 and 7.6, or a pH of about 7.3, and adjusting the pH as necessary. In some cases, the pH may be adjusted by the addition of a material capable of reducing or increasing the pH. In some embodiments, a buffered medium is used in order to maintain a stable pH medium. In some cases, the buffered medium is or comprises a buffered solution, such as a phosphate buffer.

The invention further provides:

A photo-electrochemical cell or system implementing a photoanode formed of or comprising an n-type material having a band gap below 2.5 eV and an oxidation potential of at least +1V vs. Ag/AgCl, when exposed to visible light irradiation; the n-type material being provided with an active coating and configured for generating photocurrents by oxidation of an organic material provided in an aqueous medium, without generating oxygen.

Relevant to some configurations of a cell or system of the invention, the photoanode may be of a material selected from BiVO₄, Fe₂O₃/Fe₃O₄, Fe₃O₄, Fe₂O₃, Cu₂O, CuO₂, CuO, CdS, CdSe, CdTe, and CₓN_{y}, wherein each of x and y is between 1 and 4.

Relevant to some configurations of a cell or system of the invention, the photoanode may be a BiVO₄-based photoanode.

Relevant to some configurations of a cell or system of the invention, the active coating may be formed of a material being or comprising CoP or NiP or FeP or NiOₓ.

Relevant to some configurations of a cell or system of the invention, the photoanode may be formed of BiVO₄ coated with a layer of CoP.

Relevant to some configurations of a cell or system of the invention, implementing a photocathode of a p-type material selected from p NiO, NiO/CdS, NiO/CdTe, NiO/CdSe, CuFeO₂/CuO, and CuₓO_{y}, wherein each of x and y is between 1 and 4.

Relevant to some configurations of a cell or system of the invention, the cell may be configured as a water purification system or a wastewater treatment system.

Relevant to some configurations of a cell or system of the invention, the cell may be comprising an electrode assembly comprising the photoanode and a photocathode and configured for receiving and holding the aqueous medium containing the organic material and an enzyme or a bacterium capable of generating said enzyme under anaerobic conditions.

Relevant to some configurations of a cell or system of the invention, the organic material may be a natural or synthetic organic material, a pollutant, a toxic material, a polymeric material, a decomposed organic material, or an organic waste material, soluble or insoluble in the aqueous medium.

Relevant to some configurations of a cell or system of the invention, the organic material may be a biomass.

Relevant to some configurations of a cell or system of the invention, the organic material may be a material comprising a carbohydrate, or a cellulosic material.

Relevant to some configurations of a cell or system of the invention, the organic material may be comprising at least 300 nM of cellulose.

Relevant to some configurations of a cell or system of the invention, the organic material may be or comprise cellulose.

Relevant to some configurations of a cell or system of the invention, the enzyme may be selected amongst lipases, amylases, cellulases, cellobiohydrolases, beta-glucosidases, lactases, hydrolases, lyases, ligases, and PETase.

Relevant to some configurations of a cell or system of the invention, the enzyme may be generated by bacterium selected from Clostridium, E. Coli, Bacillus, and Thermoacetica.

Relevant to some configurations of a cell or system of the invention, the bacterium may be Clostridium Thermocellum.

Relevant to some configurations of a cell or system of the invention, the cell may be configured for receiving and holding an aqueous medium containing the organic material and Clostridium Thermocellum.

Relevant to some configurations of a cell or system of the invention, the photoanode may be provided in a cellulose-containing aqueous medium comprising an anaerobic bacterium generating an enzyme capable of degrading cellulose to glucose, wherein oxidation of the glucose on the photoanode generates photocurrents, with suppression of water oxidation.

A photo-electrochemical cell configured to hold an aqueous medium comprising cellulose and an enzyme capable of degrading said cellulose or an anaerobic bacterium selected to generate said enzyme, the cell being provided with an electrode assembly comprising a BiVO₄/CoP photoanode configured in said aqueous medium and exposed to solar (or visible light) radiation.

Relevant to some configurations of a cell or system of the invention, the enzyme may be a cellulase.

Relevant to some configurations of a cell or system of the invention, the bacterium generating the enzyme may be a bacterium generating a cellulase.

Relevant to some configurations of a cell or system of the invention, the bacterium may be Clostridium Thermocellum.

Relevant to some configurations of a cell or system of the invention, the cell may be configured to hold an aqueous medium comprising at least 300 nM cellulose and Clostridium Thermocellum, the cell being provided with an electrode assembly comprising a BiVO₄/CoP photoanode configured in said aqueous medium and exposed to solar (or visible light) radiation.

Relevant to some configurations of a cell or system of the invention, the aqueous medium may be flown or mixed and maintained at a pH of between 7.1 and 7.6, and at a temperature between room temperature (23-33° C.) and 60° C.

Relevant to some configurations of a cell or system of the invention, the cell may be comprising a filter for preventing passivation of the photoanode.

Relevant to some configurations of a cell or system of the invention, the filter is a polyethersulfone (PES) filter.

Relevant to some configurations of a cell or system of the invention, the cell may be configured as an oxygen-free cell for generating photocurrents.

An oxygen-free photo-electrochemical cell for generating photocurrents, the cell comprising an aqueous medium maintained under oxygen-free conditions and comprising an organic material and an enzyme capable of degrading said organic material or an anaerobic bacterium selected to generate said enzyme, the cell being provided with a BiVO₄/CoP photoanode configured in said aqueous medium and exposed to solar (or visible light) radiation.

Relevant to some configurations of a cell or system of the invention, the organic material may be cellulose.

A process for generating photocurrents from an organic material provided in an aqueous medium, the process comprising treating an aqueous medium comprising the organic material and an enzyme or anaerobic bacteria generating said enzyme, in a system including an electrode assembly comprising a photoanode of an n-type material having a band gap below 2.5 eV and oxidation potential of at least +1V vs. Ag/AgCl, under conditions suitable for causing enzymatic decomposition of the organic material in said aqueous medium and oxidation of the decomposed material on the photoanode to generate the photocurrents.

Relevant to some configurations of a process of the invention, the process may be comprising obtaining the aqueous medium containing the organic material and treating said medium with the enzyme or the anaerobic bacteria.

Relevant to some configurations of a process of the invention, the n-type material may be selected from BiVO₄, Fe₂O₃/Fe₃O₄, Fe₃O₄, Fe₂O₃, Cu₂O, CuO₂, CuO, CdS, CdSe, CdTe, and CₓN_{y}, wherein each of x and y is between 1 and 4.

Relevant to some configurations of a process of the invention, the photoanode may be a BiVO₄ electrode.

Relevant to some configurations of a process of the invention, the photoanode may be a BiVO₄ electrode coated with a layer of CoP or NiP or FeP or NiOx.

Relevant to some configurations of a process of the invention, the organic material may be or comprise cellulose.

Relevant to some configurations of a process of the invention, the process may be for generating photocurrents from cellulose provided in the aqueous medium, the process comprising treating the aqueous medium comprising the cellulose and Clostridium Thermocellum, in a system including an electrode assembly comprising a BiVO₄/CoP, under conditions suitable for causing enzymatic decomposition of the cellulose in said aqueous medium into glucose and oxidation of the glucose on the photoanode to generate the photocurrents.

Relevant to some configurations of a process of the invention, the conditions may comprise one or more of:
the aqueous medium is at a pH of between 7.1 and 7.6, optionally comprising a phosphate buffer;
the aqueous medium is maintained at a temperature between room temperature (23-33° C.) and 60° C.;
the photoanode is exposed to solar radiation, sun light or an illumination by a light of a wavelength between 400 and 780 nm;
the aqueous medium comprises the anerobic bacterium in O.D of at least 0.9, or between 0.9 and 3;
the aqueous medium is maintained under mixing or stirring or is flown; and
the process is carried out under an oxygen-free atmosphere, wherein the oxygen concentration is below 2 ppm.

Relevant to some configurations of a process of the invention, the aqueous medium may comprise at least 300 nM cellulose.

Relevant to some configurations of a process of the invention, the process may be carried out under conditions of low applied potentials of between −0.5V and 0V vs. Ag/AgCl.

A process for generating photocurrents, the process comprising treating an aqueous medium comprising at least 300 nM cellulose and a cellulase enzyme or Clostridium Thermocellum, in a system including a BiVO₄/CoP photoanode, under light and applied potentials of between −0.5V and 0V vs. Ag/AgCl for causing decomposition of the cellulose in said aqueous medium and oxidation of the decomposed material on the photoanode to generate the photocurrents.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1. Optimization of the CoP layer to minimize water suppression. Cyclic voltammetry (CV) measurements of BiVO₄ based photo-anode before (dash line) and after photo-deposition of CoP (solid line). Two different electrode configurations were tested: high cobalt loading and low cobalt loading. Each configuration was measured with back illuminated light and without light in PB 0.2M, pH 7.3 solution. The light shadow around each curve indicates measurements error range.

FIG. 2. Cyclic voltammetry (CV) measurements of BiVO₄ based photo-anode in PB pH 7.3, 0.1M. Measurements were performed in dark (blue) and with illumination of the back side of the electrode using white LED light. Additional CV measurements were performed with 10 mM, 30 mM, and 50 mM of glucose in the cell solution while irradiating the back side of the electrode with white LED light. A scan rate of 5 mV/sec was used.

FIGS. 3A-B. Glucose oxidation by BiVO₄/CoP based a photoanode. (A) A LSV measurement of a BiVO₄/CoP based photoanode with and without 40 Mm of glucose in the cell solution. Measurement was performed using a scan rate of 5 mV/sec, scanning from −0.5V to 1.2V vs. Ag/AgCl. The light shadow around each curve indicates measurements error range. (B) Chronoamperometry (CA) measurement of BiVO₄/CoP based photoanode with and without 4 mM of glucose in the cell solution. The measurement was performed at room temperature for 48 hrs while a potential of 0V vs. Ag/AgCl was applied. All measurements were performed in 0.2M phosphate buffer (pH 7.3), while the back side of the electrode was illuminated with white LED light.

FIG. 4. Linear sweep voltammetry (LSV) measurements of BiVO₄ based photo-anode after electrodeposition of Cobalt phosphate. Electrodeposition was performed in PB pH 7, 0.1M for 30 minutes. Measurements were performed in PB pH 7.3 0.2M, with 0 mM, 10 mM, 20 mM, 30 mM, and 40 mM of glucose in the cell solution while irradiating the back side of the electrode with white LED light. A scan rate of 5 mV/sec was used. The light shadow around each curve indicates measurements error range.

FIG. 5. Cyclic voltammetry (CV) measurements of BiVO₄ based photo-anode after electrodeposition of Cobalt phosphate. Electrodeposition was performed in PB pH 7, 0.1M for 30 minutes. Measurements were performed in PB pH 7.3 0.2M, with 0 mM, 10 mM, 20 mM, 30 mM, and 40 mM of sodium sulfite (Na₂SO₃) in the cell solution while irradiating the back side of the electrode with white LED light. A scan rate of 5 mV/sec was used. The light shadow around each curve indicates measurements error range.

FIG. 6. X-Ray diffraction (XRD) pattern of BiVO₄/CoP electrode surface. The black curve illustrates the pristine BiVO₄ electrode and the blue the BiVO₄ with high loading of CoP electrode.

FIGS. 7A-C. High resolution scanning electron microscopy (SEM) surface analysis of BiVO₄ electrode (A), BiVO₄ modified with high CoP loading (B), and BiVO₄ modified with low CoP loading (C). Scale bar—200 μm.

FIGS. 8A-B. Characterization of the BiVO₄—CoP loading thickness using each CoP deposition procedure using SEM. The images were taken while the electrode was placed vertically on the SEM holder. (A) BiVO₄ modified with low CoP loading (B) BiVO₄ modified with high CoP loading. The measured thickness of the BiVO₄—CoP loading is marked on each SEM image. Scale bar-200 μm.

FIGS. 9A-C. Energy dispersive spectrometry (EDS) analysis of (A) pristine BiVO₄ electrode (B) BiVO₄ with low loading of CoP (C) BiVO₄ with high loading of CoP.

FIG. 10. Cyclic voltammetry (CV) measurements of BiVO₄ based photo-anode before and after electrodeposition of Cobalt phosphate. Electrodeposition was performed in PB pH 7, 0.1M for 30 minutes. Measurements were performed in PB pH 6.8 0.2M and in PB pH 5.8 0.2M, with irradiation of the back side of the electrode with white LED light.

FIG. 11. Half-cell optimization. Main: Chronoamperometry (CA) measurement of a BiVO₄/CoP based photo-anode with cellulose and enzymatic cellulase complex in the cell solution. The measurement was performed at 37° C. while a potential of 0V vs. Ag/AgCl was applied. Phosphate buffer (0.2M phosphate buffer, pH 7.3) with dispersed cellulose (5 mg/ml) and enzymatic cellulase complex (5 μl/ml) served as the cell solution. Inset: CA measurement of BiVO₄/CoP based photo-anode in the same conditions in the absence of cellulose and cellulase complex in the cell solution.

FIGS. 12A-B. Cellulose degradation was tested using high performance liquid chromatogram equipped with PA1 column (Dionex). Cellulose and cellulase complex were incubated for 16 hours, while samples were taken during incubation time. (A) Glucose is represented by peak area at different times: 0, 4, 10, 15 hours; (B) representative chromatogram.

FIG. 13. Calibration curve of BiVO₄/CoP based photo anode. Electrodeposition was performed in PB pH 7, 0.1M for 30 minutes. Measurements were performed in PB pH 7.3 0.2M, with 0 mM, 10 mM, 20 mM, 30 mM, and 40 mM of glucose in the cell solution while irradiating the back side of the electrode with white LED light. Cellulose and cellulase complex were incubated for 4 hours and then sample was measured for glucose quantification (dash line). A scan rate of 5 mV/sec was used.

FIG. 14. ¹H-NMR spectrum of cellulose and cellulose complex solution. The solution was incubated photo-electrochemically with BiVO₄/CoP photo anode for 69 hours. The measurement was performed in 0.2M PB, pH 7.3 while the electrode was back illuminated with white LED light under aerobic condition.

FIG. 15. ¹H-NMR spectrum of cellulose and cellulose complex solution. The solution was incubated photo-electrochemically with BiVO₄/CoP photo anode for 69 hours. The measurement was performed in 0.2M PB, pH 7.3 while the electrode was back illuminated with white LED light under anaerobic condition (O₂<0.5 ppm).

FIG. 16. LSV measurements of BOD based bio-cathode under argon, air and saturated oxygen atmosphere conditions. Measurements were performed in PB pH 7.3, 0.2M, scanning from 0.6V to 0V vs. Ag/AgCl. Scanning rate of 5 mV/sec was used. The light shadow around each curve indicates measurements error range.

FIG. 17. Image of the full photo-bio-electrochemical cell comprised of BiVO₄/CoP based photo-anode and BOD based bio-cathode. The cell solution of the anode side was enriched with cellulose and enzymatic cellulase complex while the electrode was back illuminated with white LED light.

FIGS. 18A-B. LSV measurements of the full photo-bio-electrochemical cell comprised of BiVO₄/CoP based photo-anode and BOD based bio-cathode. The cell solution of the anode side was enriched with cellulose (5 mg/ml) and enzymatic cellulase complex (5 μl/ml) while the electrode was back illuminated with white LED light. The cellulose and cellulase complex amounts were set to the cell volume of anode side. A scan rate of 2 mVs⁻¹ was used. The measurements were performed while the cathode side was subjected to oxygen saturated conditions (A) or under air (B).

FIGS. 19A-B. (A) Open circuit voltage (OCV) potential during time of the integrated photo-bio-electrochemical cell comprised of the BiVO₄/CoP based photo-anode and BOD based bio-cathode. (B) Chronoamperometry measurement of the integrated photo-bio-electrochemical cell under an applied voltage of −0.3V vs. OCV. Measurements were performed at 37° C. in PB, 0.2M pH 7.3, while the bio-cathode side was subjected to oxygen saturated conditions. The cell solution of the anode side was enriched with cellulose (5 mg/ml) and enzymatic cellulase complex (5 μl/ml) while the electrode was back illuminated with white LED light.

FIGS. 20A-B. LSV measurements of the full photo-bio-electrochemical cell comprised of BiVO₄/CoP based photo-anode and BOD based bio-cathode. The cell solution of the anode side was enriched with 40 mM of glucose while the electrode was back illuminated with white LED light. A scan rate of 2 mVs⁻¹ was used. The measurements were performed while the cathode side was subjected to oxygen saturated conditions (A) or under air (B).

FIG. 21. Open-circuit voltage (OCV) potential during time of the integrated photo-bio-electrochemical cell comprised of the BOD based a bio-cathode and BiVO₄/CoP based a photoanode. Measurements were performed at 37° C. in PB, 0.2M pH 7.3, while the bio-cathode side was subjected to oxygen saturated conditions. The cell solution of the anode side was enriched with 40 mM of glucose while the electrode was back illuminated with white LED light. The potential was recorded at 50 s interval.

FIG. 22. Chronoamperometry (CA) measurement of the integrated photo-bio-electrochemical cell comprised of the BOD based a bio-cathode and BiVO₄/CoP based photoanode. Measurements were performed at 37° C. in PB, 0.2M pH 7.3, under an applied voltage of −0.3V vs. OCV. The bio-cathode side was subjected to oxygen saturated conditions. The cell solution of the anode side was enriched with 40 mM of glucose while the electrode was back illuminated with white LED light. The potential was recorded at 50s interval.

FIG. 23. LSV measurements of the full photo-electrochemical cell comprised of BiVO₄—CoP-HL based photo-anode and Pt based cathode. The cell solution of the anode side was enriched with cellulose (5 mg/ml) and enzymatic cellulase complex (5 μl/ml) while the electrode was back illuminated with white LED light. The cellulose and cellulase complex amounts were set to the cell volume of anode side. A scan rate of 2 mVs⁻¹ was used. The measurements were performed while the cathode side was subjected to oxygen saturated conditions.

FIG. 24. CA measurement of the integrated photoelectrochemical cell comprised of the Pt based cathode and BiVO₄—CoP-HL based photoanode. Measurements were performed at 37° C. in PB, 0.2M pH 7.3, under an applied voltage of −0.25V vs. OCV. The cathode side was subjected to oxygen saturated conditions. The cell solution of the anode side was enriched with cellulose (5 mg/ml) and enzymatic cellulase complex (5 μl/ml) while the electrode was back illuminated with white LED light. The potential was recorded at 50s interval.

FIGS. 25A-B. (A) LSV measurements of BiVO₄/CoP based photo-anode with and without 40 mM of cellobiose in the cell solution. Measurements were performed in PB pH 7.3, 0.2M while the back side of the electrode was illuminated with white LED light, scanning from −0.5V to 1.2V vs. Ag/AgCl. (B) CA measurement of BiVO₄/CoP based a photo-anode with and without 40 Mm of cellobiose in the cell solution. Measurement was performed at room temperature while a voltage of 0V vs. Ag/AgCl was applied.

FIG. 26. LSV measurements.

FIGS. 27A-C. Electrochemical measurements and product analysis of MPEC comprised of BiVO₄-HL-COP as a working electrode, carbon as a counter, and Ag/AgCl as a reference electrode. Cellulose served as a substrate for the cellulolytic bacteria. The cell solution comprised of PB pH 7.3, 0.2M while the cellulolytic bacteria Clostridium Thermocellum and cellulose were separated by a polyethersulfone membrane. (A) Linear sweep voltammetry of the developed MPEC before (light blue) and after 5 hours of pre-incubation with the cellulolytic bacteria Clostridium Thermocellum and cellulose (dark blue). Scan rate of 5 mV/sec was used. The light shadow around each curve indicates the measurement error bar range. (B) Chronoamperometry measurement of the MPEC was performed for 80 hours while the photo-anode was subjected to a potential of 0V vs. Ag/AgCl. The CA test was initiated after 5 hours of pre-incubation step. (C) ¹H-NMR spectra of the samples taken from the MPEC during the chronoamperometry measurement. The measurements were performed at 60° C. under anaerobic conditions. The photo-anode was back-illuminated with white LED light (5W, LEDSupply).

FIGS. 28A-B. Electrochemical measurements performed for the MPEC comprised BiVO₄-HL-COP as a working electrode, carbon as a counter, and Ag/AgCl as a reference electrode. Fresh leaves served as a substrate for the cellulolytic bacteria. The cell solution comprised PB pH 7.3, 0.2M while the cellulolytic bacteria Clostridium Thermocellum and fresh leaves were separated by a polyethersulfone membrane. (A) Linear sweep voltammetry of the developed MPEC after 5 hours of pre-incubation step with the cellulolytic bacteria Clostridium Thermocellum and fresh leaves (red). Control experiments were performed similarly except for bacteria only (yellow) or fresh leaves only (green) present in the cell (while separated by a polyethersulfone membrane). A scan rate of 5 mV/sec was used. The light shadow around each curve indicates the measurement error bar range. (B) Chronoamperometry measurement of the MPEC after 5 hours of pre-incubation step, performed for 24 hours while the photo-anode was subjected to a potential of 0V vs. Ag/AgCl. Control experiments were performed similarly except for bacteria only (yellow) or fresh leaves only (green) present in the cell (while separated by a polyethersulfone membrane). The measurements were performed at 60° C. under anaerobic conditions. The photo-anode was back-illuminated with white LED light (5W, LEDSupply).

FIGS. 29A-B. Electrochemical measurements performed for the MPEC comprised BiVO₄-HL-COP as a working electrode, carbon as a counter, and Ag/AgCl as a reference electrode. Paper served as a substrate for the cellulolytic bacteria. The cell solution comprised PB pH 7.3, 0.2M while the cellulolytic bacteria Clostridium Thermocellum and the paper were separated by a polyethersulfone membrane. (A) Cyclic voltammetry of the developed MPEC before (yellow) and after 5 hours of pre-incubation with the cellulolytic bacteria Clostridium Thermocellum and the paper (red). A scan rate of 5 mV/sec was used. (B) Chronoamperometry measurement of the MPEC after 5 hours of pre-incubation step, performed for 65 hours while the photo-anode was subjected to a potential of 0V vs. Ag/AgCl. The measurements were performed at 60° C. under anaerobic conditions. The photo-anode was back-illuminated with white LED light (5W, LEDSupply).

### DETAILED DESCRIPTION OF EMBODIMENTS

### Results and Discussion

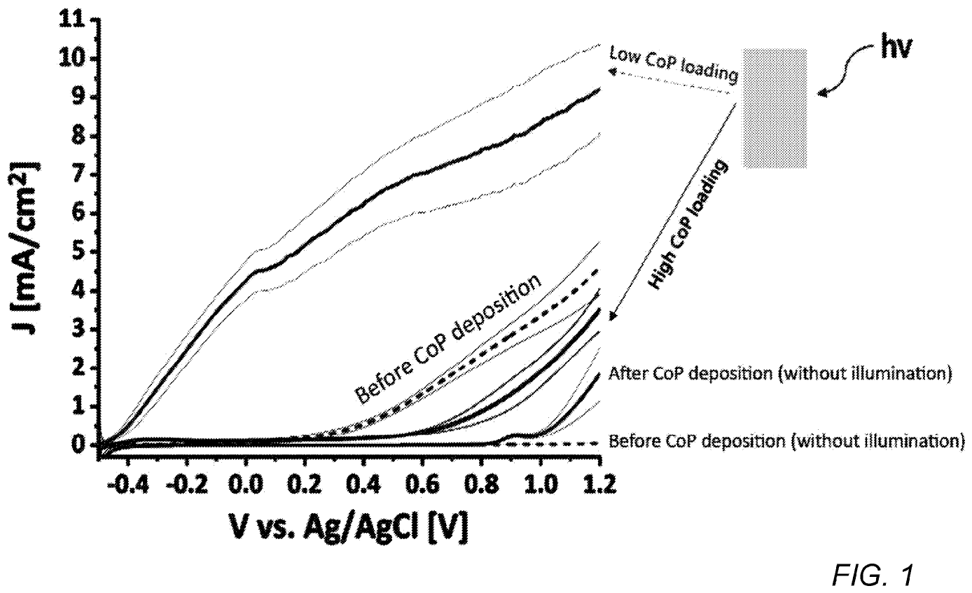

Pristine BiVO₄ photo-anode was fabricated as known in the art. The prepared BiVO₄ photoanode was tested for water oxidation FIG. 1.

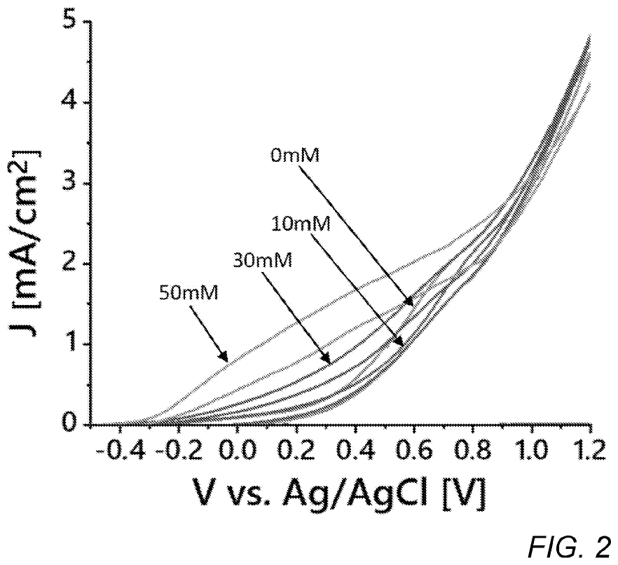

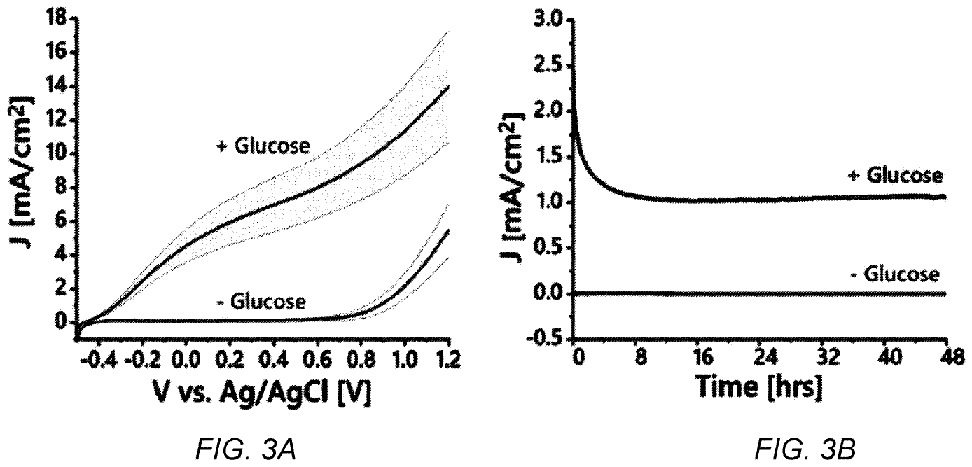

As depicted, the water oxidation reaction onset potential occurred at 0.15V vs. Ag/AgCl under light irradiation. An addition of 10 mM of glucose into the cell solution resulted in a minor onset potential shift, which becomes significant only at higher glucose concentrations of 30 mM and 50 mM, FIG. 2. Thus, the photocurrent that can be attributed to glucose oxidation was mostly limited by the added concentrations. On the other hand, photo-assisted water oxidation dominated the generated photocurrents over glucose oxidation. Therefore, to improve glucose oxidation efficiency, the photo-assisted water oxidation reaction must be suppressed. It has been shown that the addition of metal oxide layers on top of a BiVO₄ photo-anode can greatly improve the water oxidation reaction rates. For example, CoP has been previously examined as a co-catalyst in conjugation with BiVO₄-based photoanode. Cobalt phosphate layer that deposited on top of the BiVO₄ improves the photoanode water oxidation performance by minimizing the hole accumulation at the electrode surface interface. In addition, the CoP co-catalyst lowers the required overpotential and enables the generation of substantially higher photocurrents. While high water oxidation rates at lower overpotential are desired, we aimed to maintain the high oxidation capabilities, however, in parallel to fully suppress the water oxidation which may act as a competitive reaction. It was hypothesized that by controlling the co-catalyst layer thickness and morphology, we can tube the electrode properties and achieve the desired function. Therefore, the cobalt phosphate loading was optimized by optimizing the electrodeposition time. First, CoP was photo-deposited on the BiVO₄ electrode for 5 minutes. The results presented in FIG. 1; purple indicate an increase in the water oxidation reaction reaching 4 mA/cm² at 0V vs. Ag/AgCl as compared to the negligible current achieved by the pristine BiVO₄ at the same applied potential. We then examined higher CoP loading on the electrode surface using an electrodeposition time of 30 minutes. The results presented in FIG. 1; pink indicate that the BiVO₄-based photo-anode modified with high Co—P loading (BiVO₄-HL-CoP) fully suppressed the water oxidation reaction at low applied potentials. It should be noted that for full water oxidation reaction suppression, the Phosphate buffer concentration was increased to 0.2M. This suppression phenomenon has been previously investigated and attributed to the accumulated holes in the thicker CoP loading. The developed photoanode was then tested under light irradiation with increasing glucose concentrations in the cell solution. The results shown in FIG. 3 and FIG. 4 indicate that rising glucose concentrations in the cell solution result in increasing photo-electrocatalytic currents at 0V vs. Ag/AgCl.

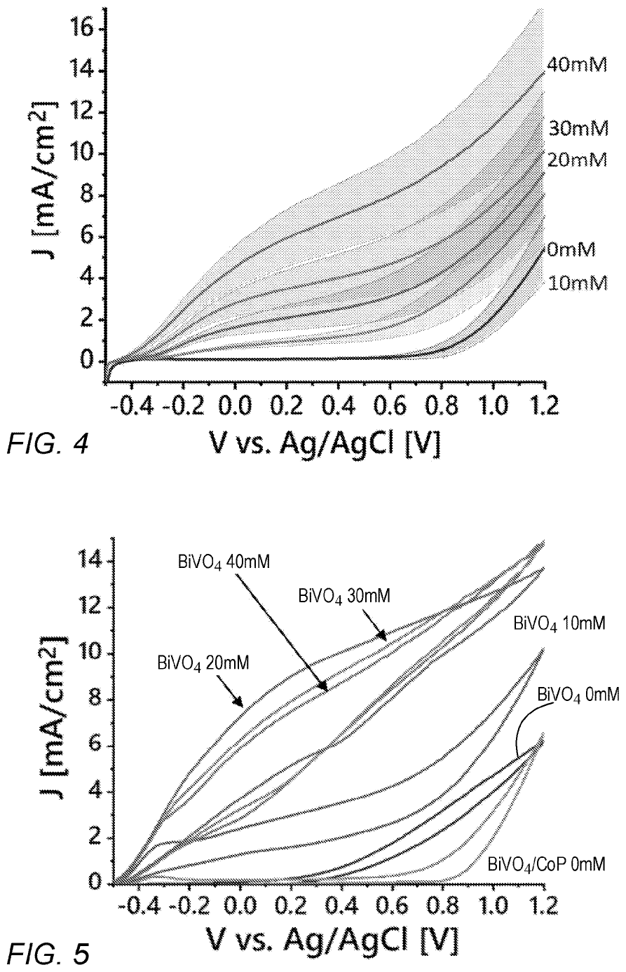

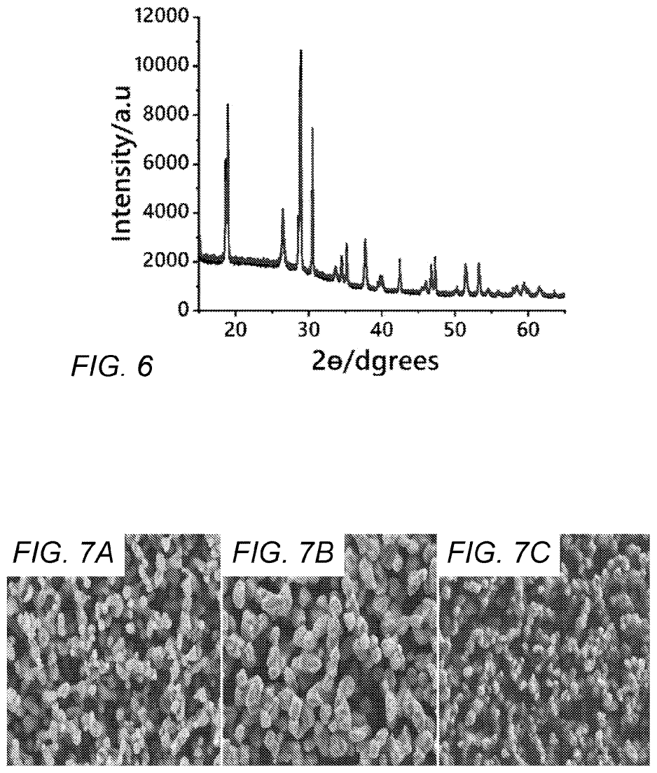

The onset potential for the glucose oxidation reaction by the BiVO₄-HL-COP is-0.45V vs. Ag/AgCl (FIG. 3, FIG. 4) and the generated photocurrents were at least 4 times higher than the one achieved by the pristine BiVO₄ photoanodes (FIG. 1). The obtained results suggest that the thicker CoP layer band structure dictates selective oxidation. The potential required for glucose oxidation is lower than water, therefore, the results can be attributed to the valance band position change which limits the water oxidation reaction. We then tested sodium sulfite as an electron donor that has higher oxidation potential; a similar trend was achieved, FIG. 5. These results support that down-ward-shifted potential change occurs which favors glucose oxidation while thermodynamically limits the water oxidation reaction. Using XRD measurements (FIG. 6) we could not observe any lattice change at the CoP band structure; however, further investigation should be performed to clarify this issue.

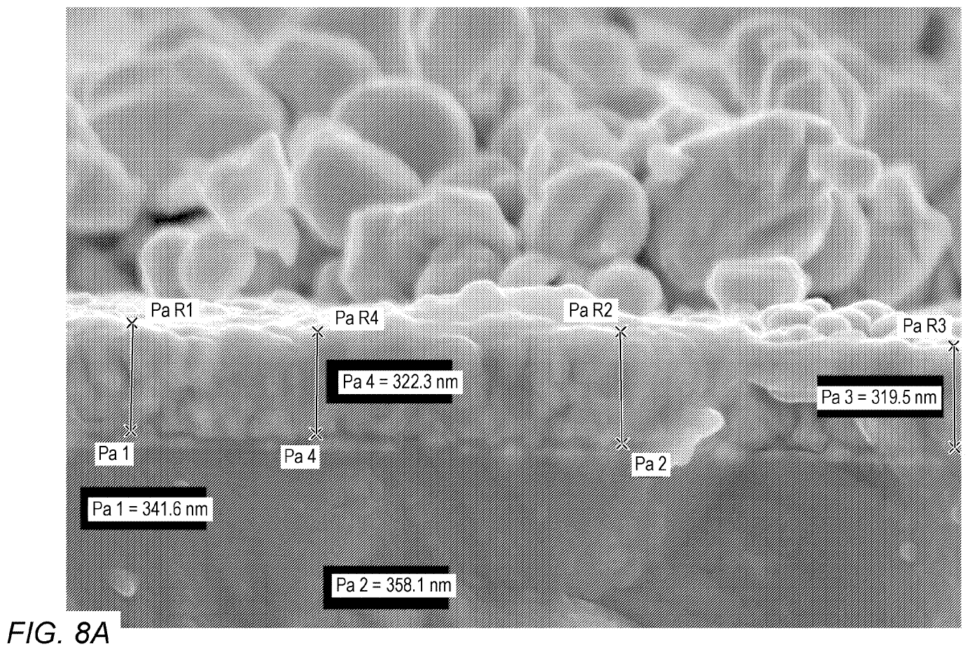

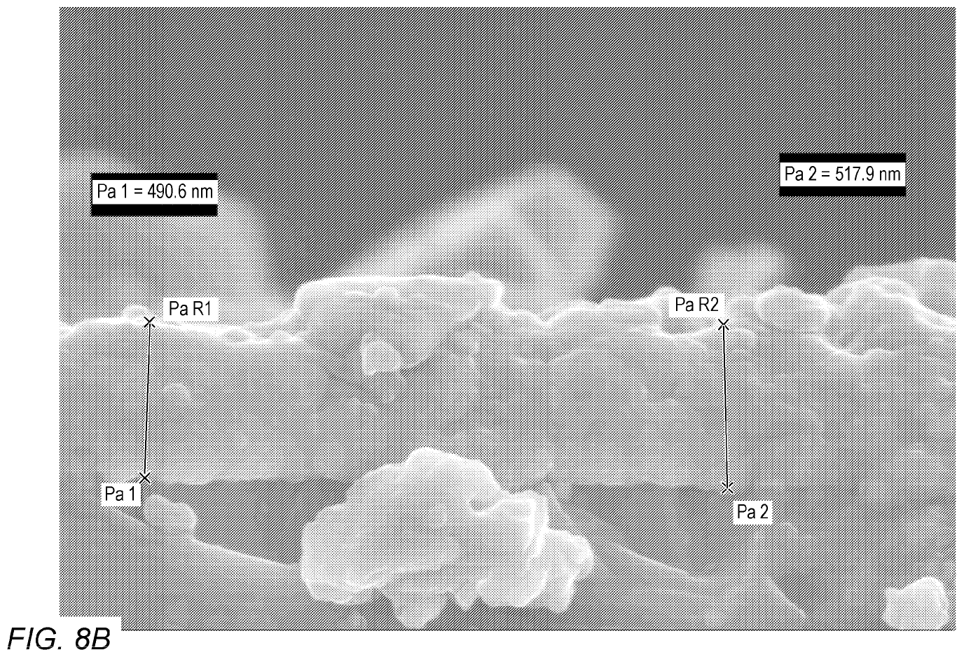

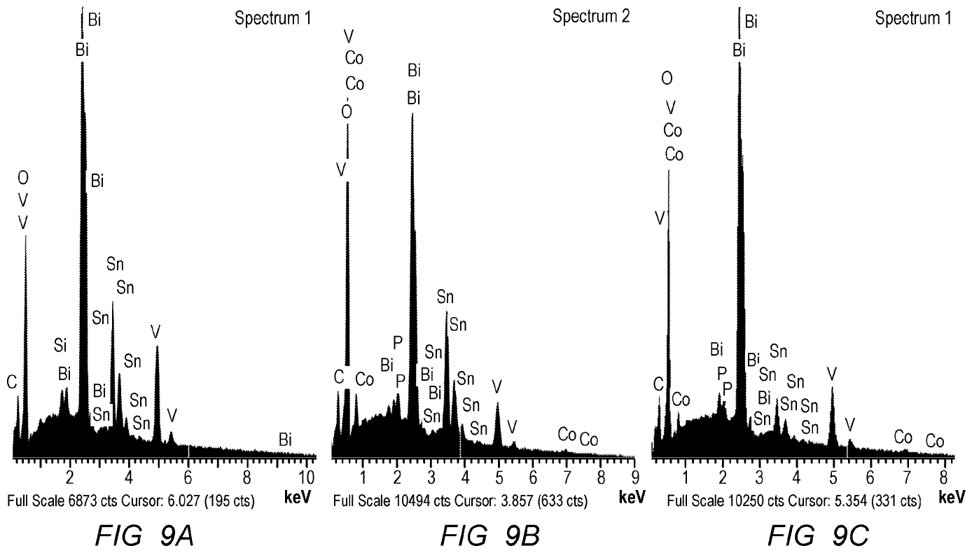

The BiVO₄-HL-COP surface was further characterized using scanning electron microscopy (SEM). A similar surface pattern was observed for the pristine BiVO₄ and BiVO₄—CoP photoanode modified with the low CoP, FIG. 7. The thicker CoP loading exhibited larger structured morphology with lower surface area as compared to the other configurations, FIG. 7B. Cross-section measurements of the photoanodes modified with high or low loading of CoP were performed. As depicted in FIG. 8, the BiVO₄—CoP loading thickness is ca. 500 nm and 320 nm for the high and low CoP loading, respectively. Energy dispersive spectrometry (EDS) analysis confirmed the presence of bismuth, vanadium, and cobalt atoms on the photoanode surfaces regardless of the cobalt modification procedure employed, FIG. 9. The content amount of cobalt deposited on the BiVO₄-based photo-anode was analyzed by inductively coupled plasma-optical emission spectrometry (ICP-OES), the results are presented in Table 1. As depicted, The ICP-OES results confirmed a 1:1 molar ratio between the bismuth and vanadium deposited on the examined electrodes (Table 1). Moreover, the results showed that the content of cobalt deposited on the BiVO₄ electrode surface was two times higher when the 30-minute CoP electrodeposition procedure was employed, as compared with the 5 minutes photo-deposition procedure (218 nmol vs. 93 nmol, respectively).

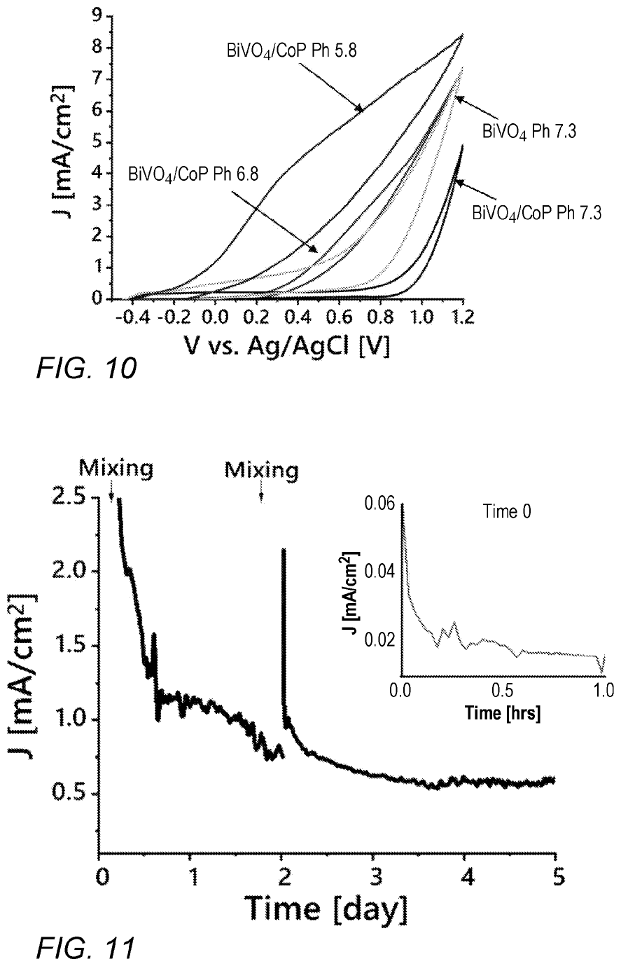

Photo-oxidation of glucose to electrical power is desired, however, direct conversion of the raw biomass material like cellulose has higher importance. Glucose can be produced by chemical or enzymatic degradation processes. Cellulase complex comprises exoglucanase, endoglucanase, and beta-glycosidase enzymes which act synergistically for cellulose degradation into cellobiose and glucose monomers. Optimal conditions for cellulase complex activity include acidic pH (4-5), yet these conditions are not optimal for the abiotic photoanode. Therefore, we examined the optimal conditions by measuring the BiVO₄-HL-COP activity at different pH values, pH 7.3 pH 6.7, and 5.8, and compared it with the pristine BiVO₄. As depicted in FIG. 10, only pH 7.3 fully suppressed the water oxidation reaction. Therefore, all further measurements were conducted at pH 7.3, 0.2M PB. To estimate the electrode stability under light irradiation, we performed chronoamperometry (CA) measurements. The results presented in FIG. 3B indicated that the BiVO₄-HL-COP is remarkably stable for at least 48 hrs. While a potential of 0V vs. Ag/AgCl is applied. As depicted, the photocurrents were maintained at 1 mA/cm² in the presence of 40 mM of glucose in the cell solution. A control experiment that lacks glucose was also performed. As depicted, no photocurrents were observed indicating that the generated photocurrent can't be attributed to water oxidation. Furthermore, we examine if oxygen is being generated by the photoanode using GC-TCD. These experiments were performed in a sealed cell pre-filled with argon. The obtained results indicated that no oxygen has been generated. A three-compartment photo-electrochemical cell was then constructed using BiVO₄-HL-CoP-based photoanode in the presence of cellulose and enzymatic cellulase complex in the cell solution. The glucose monomers, formed by the enzymatic cellulase complex were subsequentially oxidized by the BiVO₄-HL-CoP electrode to generate photocurrents. CA measurements were then performed. A four hour-pre-incubation step was added to allow the production of glucose by the enzymatic cellulase complex, FIG. 11.

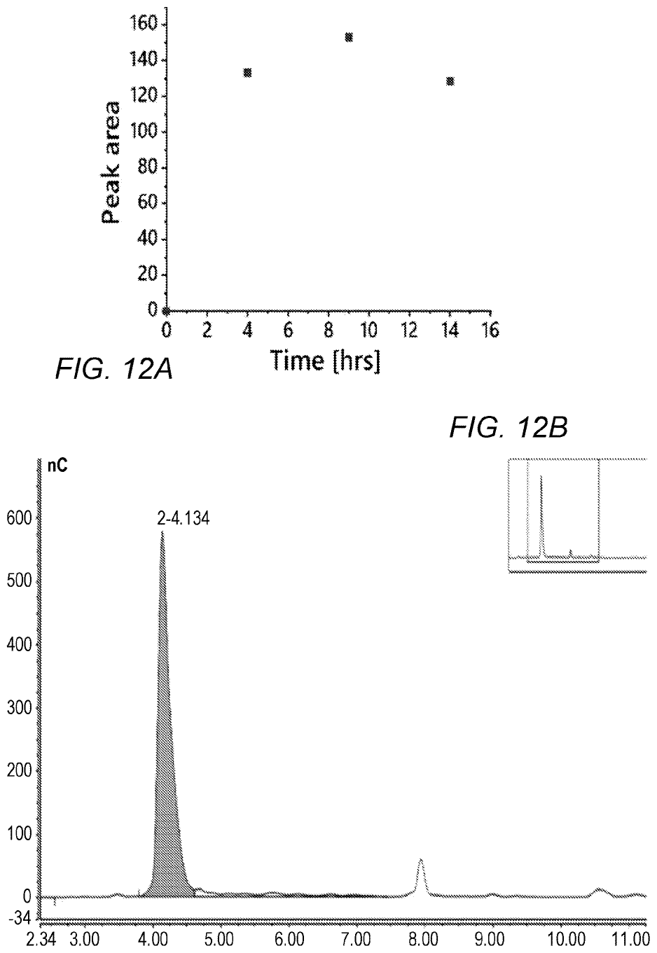

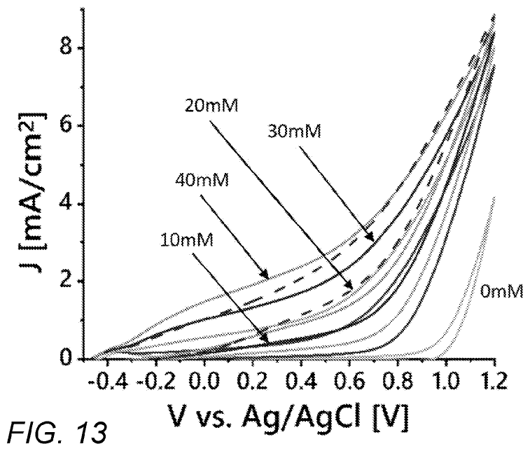

As depicted, after four hours of the pre-incubation a maximal anodic photocurrent of 2.5 mA/cm² was achieved. Through five days of continuous measurements, we could observe a gradual photocurrent decrease, reaching 600 μA/cm². Overall, the BiVO₄-HL-CoP photoanode was stable for at least five days, during that course, the solution was stirred twice to minimize glucose diffusion barriers, FIG. 11. The presence of glucose was verified using a liquid chromatogram equipped with a PA1 column (Dionex), FIG. 12. The glucose amount was then quantified as depicted in FIG. 13. The results indicate that ca. 30 mM of glucose was released to the cell solution due to cellulase activity.

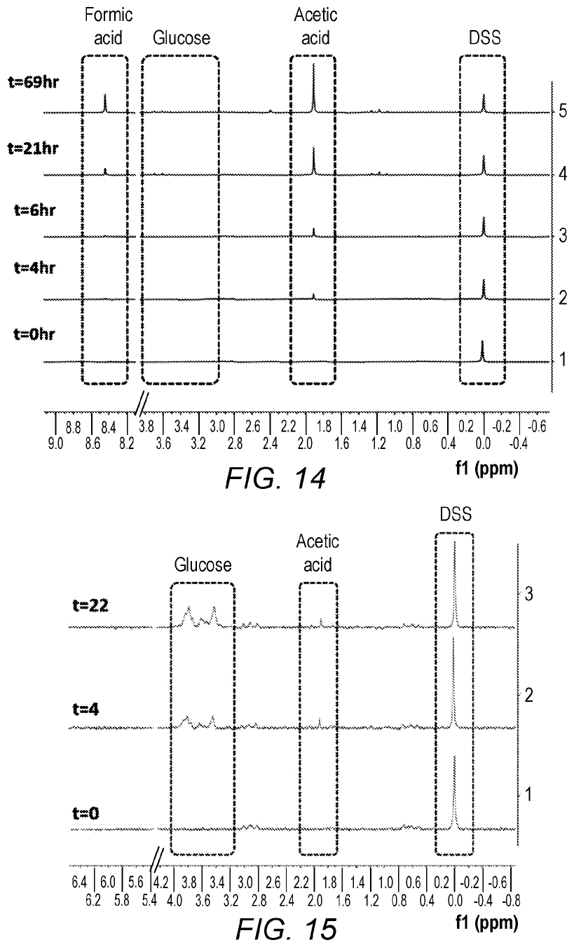

Glucose oxidation by natural oxidizing enzymes (glucose oxidase, glucose dehydrogenase) generates gluconic acid, 2H+, and 2e⁻. We hypothesized that different oxidation routes may occur in the presented configuration. Alternative oxidation routes that are dictated by the high oxidation potential developed by the BiVO₄ may lead to different products. Full oxidation of glucose molecule into CO₂ may lead to a total gain of 24e″, therefore, improving its oxidation can be greatly beneficial in terms of energy efficiency. To better understand the mechanism in our developed system, the cell solution was monitored using ¹H-NMR spectroscopy (Spinsolve, Magritek Ultra) designed with water suppression capabilities. The resulting spectrum measured after 3 days of continuous reaction is presented in FIG. 14. Surprisingly, we could observe two peaks that have been formed and cannot be attributed to the glucose NMR spectra. By spiking the samples with reference solutions, singlet peaks at 8.45 ppm and 1.95 ppm were determined as formic and acetic acid respectively. These results suggest that the BiVO₄-HL-CoP photoanode can exceed the two electrons photo-oxidation to gluconic acid as achieved in our previous work. Glucose oxidation to formic acid and acetic acid has been recently investigated, presenting important mechanistic information. It has been shown that oxygen is required for formic acid or acetic acid production. Therefore, we examined if indeed oxygen is required for the electrocatalytic process by ¹H-NMR spectroscopy. As depicted in FIG. 15, the oxygen-free measurements show that the glucose amounts formed have decreased by half as compared to the oxygenic conditions. We could also observe that no formic acid and a 50% lower amount of acetic acid have been generated. These results highlight two important points. (i) oxygenic conditions are important for the cellulose degradation reaction by the cellulase complex. (ii) Independent of the lower amounts of glucose generated, different routes dictate the photo-oxidation.

Under oxygenic conditions, both acetic acid and formic acid can be formed, however, under oxygen free the formic acid production is depleted. Taking into account that the generated photocurrent was not significantly altered under air, we postulate that formed oxygenic radicals expedite the carbon-carbon breakage toward the generation of formic acid, and enhanced acetic acid.

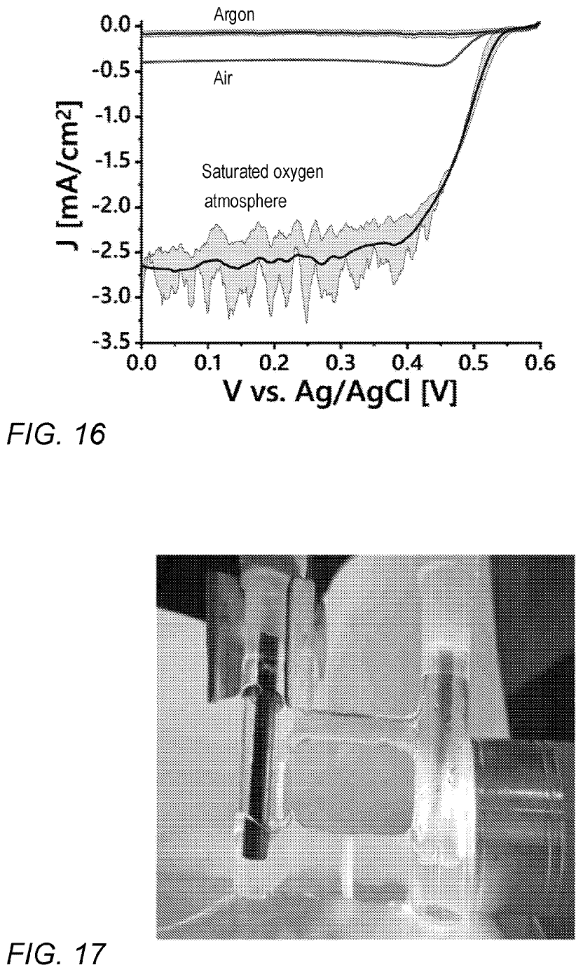

While the developed photoanode presents a great platform for photocurrent generation using glucose as a fuel, a bias of 0V vs. Ag/AgCl was applied for the activation. To achieve a bias-free configuration, and to maximize the developed open circuit voltage between the photo-anode and the cathode which serves as the driving force, a cathode with more positive potential should be used. Therefore, we examined two cathodes, an enzymatic cathode consisting of bilirubin oxidase and an abiotic Pt wire. The bilirubin oxidase-based bio-cathode has been prepared as previously described where ABTS acts as redox mediator and polydopamine serves as stabilizing layer. The bio-cathode was tested in PB pH 7.3, 0.2M while the cell solution was enriched with argon, air, or saturated oxygen atmosphere. The results presented in FIG. 16 indicated that under a saturated oxygen atmosphere, a maximal cathodic bio-electrocatalytic current of ~2.7 mA/cm² can be achieved. The BiVO₄-HL-CoP-based photoanode was then coupled with the BOD-based bio-cathode to construct a bias-free photo-bio-electrochemical cell.

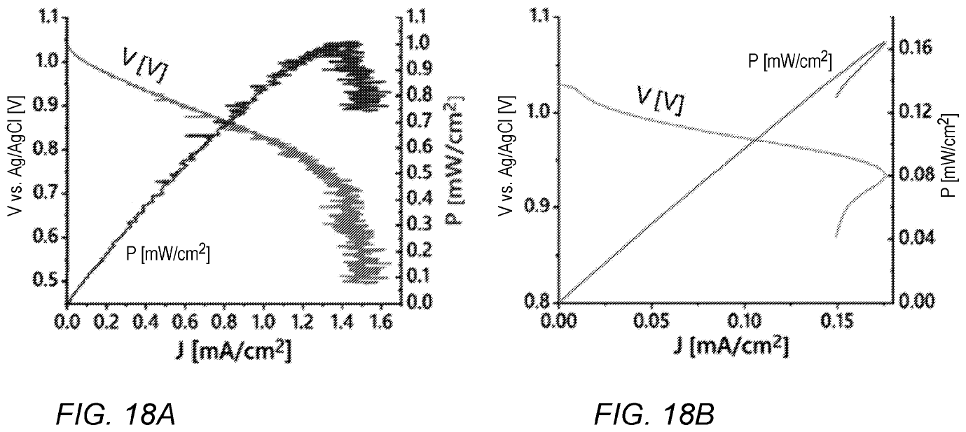

Phosphate buffer pH 7.3, 0.2M was used as the electrolyte in the H-cell while the electrode compartments were separated by a non-selective glass frit membrane, FIG. 17. The enzymatic cellulase complex and the cellulose were added to the photoanode compartment and the photo-anode was subsequentially irradiated with a white LED light, FIG. 17. The non-selective membrane prevented diffusion of the enzymatic cellulase and cellulose toward the bioanode compartment, FIG. 17. Polarization measurements were performed to characterize the photo-bio-electrochemical cell performance. The cell was examined after pre-incubation for 4 hours. The conjugated bio-cathode was kept under air or a saturated oxygen atmosphere. The obtained results are presented in FIG. 18.

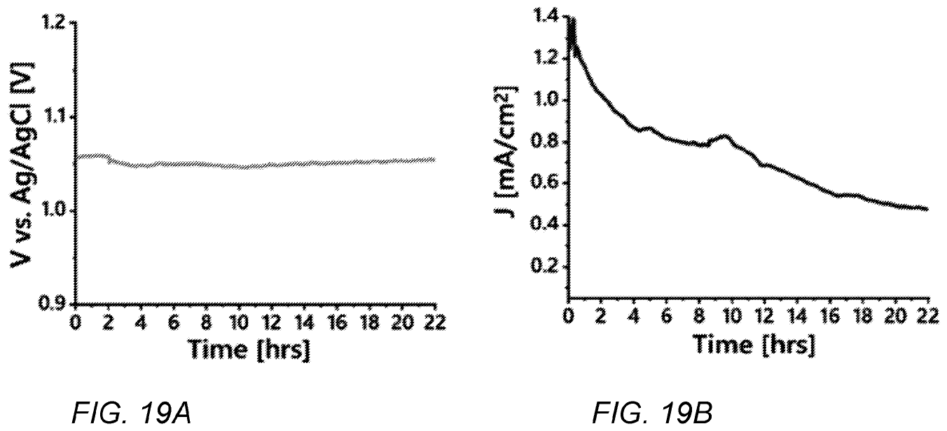

The cell OCV is dictated by the onset potentials of the photoanode and the bio-cathode. Therefore, considering that the BiVO₄-HL-CoP onset potential is ca −0.48V (FIG. 3) and the Bilirubin oxidase-based bio-cathode is at +0.5V (FIG. 16) vs. Ag/AgCl we expected an OCV of 1V under irradiation. In accordance, an OCV of 1 V vs. Ag/AgCl was observed under oxygen saturated atmosphere or air, FIG. 18A and FIG. 18B respectively. The photo-bio-electrochemical cell was further polarized under air and oxygen-saturated atmosphere and the power, and the power outputs were determined. Maximal power outputs of 1 mW/cm² and 0.16 mW/cm² were achieved under oxygen saturated atmosphere and air, respectively. We attributed the higher power output gained to improved bio-cathode performance under oxygen-saturated atmosphere conditions. The stability of the constructed photo-bio-electrochemical cell was further examined by following the OCV over time. The results, presented in FIG. 19A, indicate that the voltage remained stable under continuous irradiation for at least 24 hours.

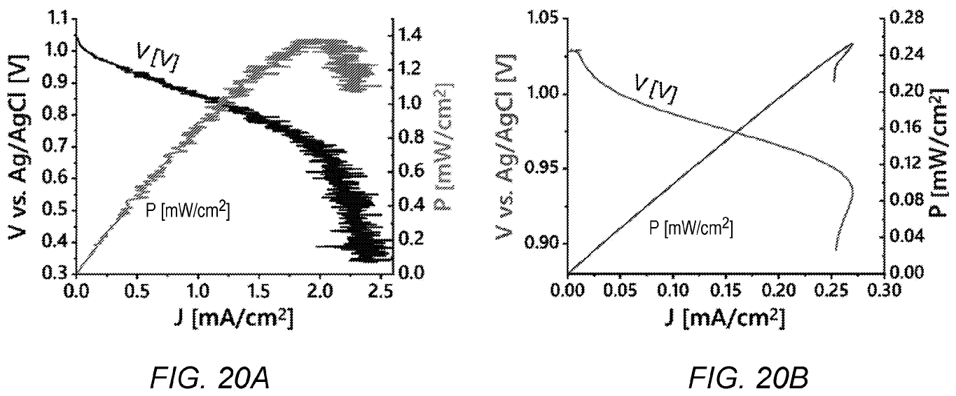

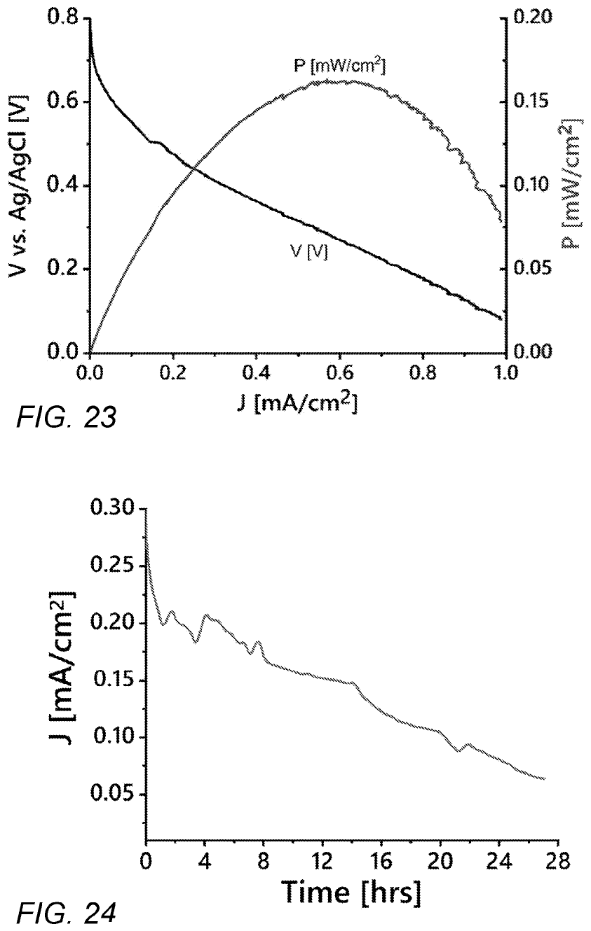

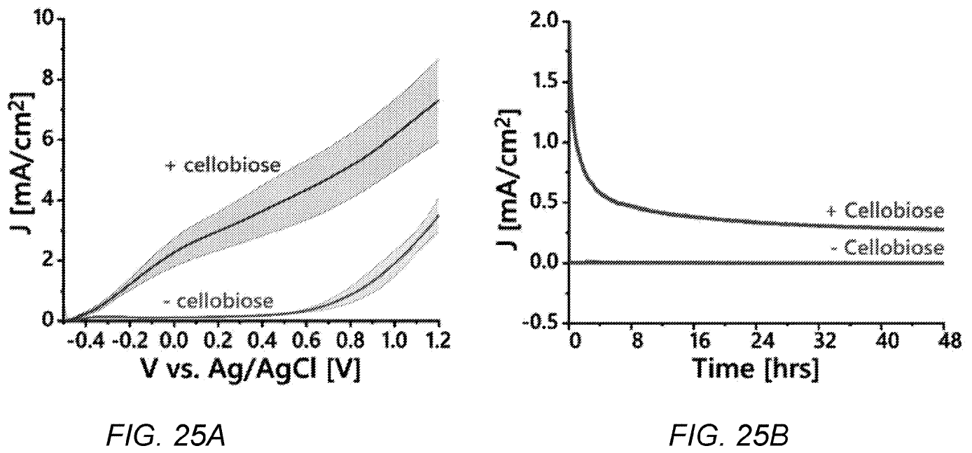

While the OCV measurements provide important information regarding the PEC performance, it is essential to examine the cell current flow while activated. Therefore, chronoamperometry measurements were performed at −0.3V vs. OCV (two electrodes configuration). The results, presented in FIG. 19B show that high photocurrent generation was maintained for at least 22 hrs. A 60% current loss was observed during the continuous operation measurement. The current loss was attributed to the bio-cathode failure, due to the degradation occurring throughout the measurement. Similar trends were achieved when the cellulase and cellulose solution was replaced with a glucose solution, FIGS. 20-22. We then replaced the bio-cathode with an abiotic Pt wire, FIGS. 23-24. As depicted, the performance of the cell falls sharply as compared to the bio-based cathode with a magnitude of order lower power output and currents. Also, the Pt electrodes didn't yield any stability improvement to the PEC. These results clearly demonstrate the great advantages of a biotic/abiotic photo-bio-electrochemical cell design. Furthermore, it shows great promise toward biotic-abiotic photo-bio-electrochemical cells which harness both the robustness of photo-anodes and the superior bio-catalytic or bio-electrocatalytic activity of enzymes. In the presented research, an isolated cellulase complex was used for the full conversion of cellulose to glucose. However, in nature, bacteria, e.g. Clostridium, secretes the cellulase complex to its surrounding to allow the cellulose degradation into a different product, the di-glucose, cellobiose. The cellobiose is then absorbed into the cell to be degraded into glucose monomers via additional enzymes. Most natural organisms can't consume the cellobiose, therefore, competition for food or energy source is prevented. For practical application, replacing isolated enzymes with bacteria has great advantages. It should be noted that clostridium is a strictly anaerobic bacteria, hence, the suppression of the oxygen evolution reaction that takes place in our design has a great advantage. We, therefore, examined if the developed photo bio-electrochemical cell can be further used for direct cellobiose oxidation. As presented in FIG. 25A, indeed the cellobiose can be oxidized by the photoanode, however, lower photocurrents have been achieved compared to glucose addition. We then examined the long-term oxidation performance. As depicted in FIG. 25B, photocurrent could be measured for at least 48 hrs, however, lower activity has been achieved and further optimization should be performed. The obtained results lay the ground for a biotic abiotic photo microbial fuel cell for electrical energy generation.

### Experimental

### BiVO₄ Photoanode Fabrication

The photo-anode was fabricated as known in the art. Briefly, fifty milliliters of an aqueous plating solution containing Bismuth (III) nitrate pentahydrate (0.015M), potassium iodide (KI, 0.4M), and lactic acid (0.03M) was prepared. Three drops of Nitric acid were then added. An additional solution was prepared by dissolving benzoquinone in ethanol (0.046M, final volume of 20 ml). The benzoquinone solution was then added slowly to the plating solution. A three-compartment electrochemical cell was then used comprised of fluorine-doped tin oxide (FTO) as the working electrode, Ag/AgCl (3M KCl) as a reference electrode, and carbon as a counter. The FTO electrodes were cleaned by sonication in ethanol at 60° C. for 10 minutes prior to the deposition procedure. For the BiOI film deposition, a potential of −0.35V vs. Ag/AgCl was applied for 20s, followed by an application of −0.1V vs. Ag/AgCl until 0.37 C/cm² was passed. To convert BiOI film to BiVO₄, the electrode surface was covered with 150 μl of vanadyl-acetylacetonate solution (200 Mm, dissolved in Dimethyl sulfoxide). The electrodes were then dried at 100° C. for 1 hr until a complete Dimethyl sulfoxide evaporation was achieved. Then, the electrodes were annealed at 450° C. for 2 hr with a ramping rate of 2° C./min. The cooling step lasts 30 minutes. Finally, the electrodes were soaked in NaOH (1M) solution for 30 minutes while gently shaking to remove V₂O₅ excess.

Low-Loading BiVO₄ Photoanode Surface with CoP

Two different methods were used for BiVO₄ photo-anode surface loading with CoP. First, CoP was photo-deposited on the BiVO₄ electrode surface as previously described by Zhong et al. with several modifications. Briefly, a solution containing 14.5 mg of cobalt nitrate hexahydrate dissolved in 100 ml of PB, pH 7, 0.1M was prepared. This solution was then placed in a three-compartment electrochemical cell comprised of BiVO₄ photo-anode as the working electrode, Ag/AgCl (3M KCl) as a reference electrode, and carbon as a counter. The Co—P was then photo-deposited on the BiVO₄ surface by applying −0.2V vs. Ag/AgCl while the back side of the electrode was illuminated with white LED light.

High-Loading BiVO₄ Photoanode Surface with CoP

Higher loading of the CoP on the BiVO₄ photo-anode surface was gained using the method described by Chadderdon et al. For that, the CoP solution and the electrochemical cell were prepared as described above. The Co—P was then electro-deposited on the BiVO₄ surface by applying 1.1V vs. Ag/AgCl for 30 minutes.

### BOD Based a Cathode Fabrication

The cathode was prepared according to a previously described method. Briefly, Glassy Carbon electrodes (GCEs, 0.07 cm² surface area) were cleaned with 1 μm and 0.05 μm alumina beads in a sequence. The electrodes were washed with 70% ethanol and deionized water and then dried under atmospheric conditions. Five milligrams of multi-walled carbon nanotubes ((MWCNTs) were suspended in 1 ml of Dimethylformamide (DMF) followed by a 30-minute sonication step at room temperature, to increase solubility. Five microliters of the MWCNT suspension were deposited on each GCE electrode surface followed by drying under vacuum conditions for 1 hr at room temperature. Afterward, 1 mg of 2,2′-azino-bis(3-ethylbenzothiazoline-6-sulfonic acid) diammonium salt (ABTS) and 1 mg of dopamine were mixed in 5 ml of 0.05M phosphate buffer (pH 8.5). Then, 10 μl of BOD stock solution (0.8 mg/ml, dissolved in PB pH 7.3, 0.1M) was mixed with 5 μl of ABTS-Dopamine solution. The BOD-ABTS-Dopamine solution was deposited on the GE/MWCNTs followed by a drying step.

### Photo-Bio-Electrochemical Cell Construction

The bio-cathode and the BiVO₄/CoP photo-anode were coupled in two electrode cell configurations. Accellerase 1500 was used as a cellulase enzymatic complex. In the two-electrode cell configuration, the cathode side was enriched with oxygen. Cellulase (5 μl/ml) enzyme and cellulose (5 mg/ml) suspended in PB pH 7.3, 0.2M were added to the anode side and the photo-anode was illuminated with white Led light. The measurements were performed at 37° C. with a scan rate of 2 mVs⁻¹.

### 1. Photo-Anode Optimization

1.1 Pristine BiVO₄ Photo-Anode Measurement with Increasing Glucose Concentration in the Cell Solution

BiVO₄ photo-anode was prepared as described previously. To evaluate the ability of the pristine BiVO₄ photo-anode to oxidize glucose, cyclic voltammetry (CV) measurements were performed in a three-electrode cell configuration comprising Ag/AgCl (3M) as a reference electrode, carbon as a counter and PB pH 7.3, 0.1M as the cell solution. The photo-anode was illuminated with white LED light. CV measurements were performed without and with 10 mM, 30 mM and 50 mM of glucose in the cell solution. Results are presented in FIG. 2.

1.2 Measurement of BiVO₄ Modified with High CoP Loading with Increasing Glucose/Sodium Sulfite Concentration in the Cell Solution

Electrodeposition of CoP on the BiVO₄ surface was performed according to a previously describe method. Cyclic voltammetry measurements were then performed to evaluate whether the water oxidation reaction was suppressed. Therefore, the BiVO₄ electrode was measured after the photo-deposition procedure in dark or while the photo-anode was illuminated with white LED light. Measurements were performed in PB pH 7.3, 0.2M without or with 10 mM, 20 mM, 30 mM, and 40 mM of glucose and sodium sulfite in the cell solution. Results are presented in FIG. 4 and FIG. 5, respectively.

### 2. BiVO₄/CoP Photoanode Characterization

### 2.1 X-Ray Diffraction (XRD) of BiVO₄—CoP Analysis

The pristine BiVO₄ and BiVO₄ modified with high loading of CoP was analyzed using XRD technique. The XRD analysis is presented in FIG. 6.

### 2.2 BiVO₄—CoP Surface Characterization

The surface of the pristine BiVO₄, and of BiVO₄ modified with high or low loading of CoP was characterized using high resolution scanning electron microscopy (SEM). The SEM images are presented in FIG. 7. To analyze the thickness, the BiVO₄-CoP loading on the electrode using each CoP deposition procedure, the electrodes were cut (dimensions of 0.5×0.9 cm²) and were placed vertically on the SEM holder, FIG. 8. In addition, characterization of electrode components was examined using Energy dispersive spectrometry (EDS) analysis, FIG. 9.

### 2.3 Quantification of Cobalt Deposited on the Electrode Surface

To quantify the number of cobalt moles deposited on the electrode surface in each deposition method, the BiVO₄ photoanodes deposited with either with high or low loading of CoP was placed in a glass tube containing 0.7 ml of nitric acid 70% (BioLab). After 2 hours the typical yellow color of the BiVO₄ photoanode completely disappeared indicating that the electrode BIVO₄/CoP coating washed off the electrode into the acid. The electrodes were then taken out of the glass tube and the nitric acid solutions were diluted to 2% (V/V) with DDW. The samples were then filtered using 0.22 μm filter and measured via Inductively coupled plasma-optical emission spectrometry (ICP-OES, Thermo-Fisher Scientific). Bismuth and Vanadium content were monitored in addition to Cobalt to ensure that identical BiVO₄ layer was deposited on the electrode before the CoP loading. The number of Bismuth, Vanadium and Cobalt moles were quantified at 223.061, 309.311 and 228.616 wavelengths respectively. The results are summarized in Table 1.

Table 1. The number of Bismuth, Vanadium, and Cobalt moles were quantified. The analysis was performed on BiVO₄ electrode with high CoP loading, low CoP loading, and after stability test for 48 hours.

| Moles | After stability test | Thin layer | Thick layer |
|---|---|---|---|
| Bi 223.061 | 9.72 · 10⁻⁷ | 1.04 · 10⁻⁶ | 9.77 · 10⁻⁷ |
| Co 228.616 | 3.05 · 10⁻⁷ | 9.34 · 10⁻⁸ | 2.18 · 10⁻⁷ |
| V 309.311 | 8.65 · 10⁻⁷ | 9.23 · 10⁻⁷ | 9.32 · 10⁻⁷ |

### 2.3 the Effect of Cell Solution pH on Water Oxidation

To test the effect of cell solution pH on the water oxidation reaction cyclic voltammetry measurements were performed. For that, BiVO₄ photoanode was measured before and after modification with high loading of CoP. Measurements were performed in PB pH 6.8 and 5.8, 0.1M in dark or while the photo-anode was irradiated with white LED light. The results are presented in FIG. 10.

### 3. Glucose Formation Quantification

Glucose formation was tested using high performance liquid chromatogram equipped with PA1 column (Dionex). Cellulose and cellulose enzymatic complex were incubated for 16 hours while samples were taken. The results are depicted in FIG. 12. To quantify glucose amount BiVO₄/CoP photoanode was tested with increasing glucose concentrations (10-40 [mM]) as described in FIG. 13. Cellulose and cellulose enzymatic complex sample after 4 hours was measured. The glucose amount is ca. 30 [mM].

### 4. Oxidation Products Analysis Using ¹H-NMR

The obtained products were examined using ¹H-NMR as described in FIG. 14 (aerobic condition) and FIG. 15 (anaerobic condition). Cellulose and cellulose complex were suspended in 0.2M PB, pH 7.3 and measured for 69 hours and 22 hours, respectively. Photo-electrochemical measurement of BiVO₄/CoP was performed in the cell solution while samples were taken at different times. Each sample was mixed with sodium trimethylsilylpropanesulfonate (DSS, NMR standard).

### 5. Bilirubin-Oxidase Based Cathode-Fabrication and Characterization

Bilirubin oxidase (BOD) based cathode was prepared according to a previously reported method. Linear sweep voltammetry (LSV) measurements of the BOD based bio-cathode under argon, air and under saturated oxygen atmosphere conditions were performed. Measurements were performed in PB pH 7.3, 0.2M, scanning from 0.6V to 0V vs. Ag/AgCl. Scanning rate of 5 mV/sec was used. Results are presented in FIG. 16. The light shadow around each curve indicates measurements error range.

### 6. Full Cell Performance Characterization

### 6.1 Full Photo-Bio-Electrochemical Cell Construction

The bio-cathode and the BiVO₄/CoP photo-anode were coupled in a two-electrode cell configuration to construct a full photo-bio-electrochemical cell. Accellerase 1500 was used as cellulase enzymatic complex. In the two-electrode cell configuration the cathode side was enriched with oxygen. Cellulase (5 μl/ml) enzyme and cellulose (5 mg/ml) suspended in PB pH 7.3, 0.2M served as the cell solution in the anode side and the photo-anode was illuminated with white LED light. The measurements were performed at 37° C. with a scan rate of 2 mVs⁻¹. Image of the full photo-bio-electrochemical cell is presented in FIG. 17.

6.2 Characterization of Cell Performance with Glucose in the Cell Solution

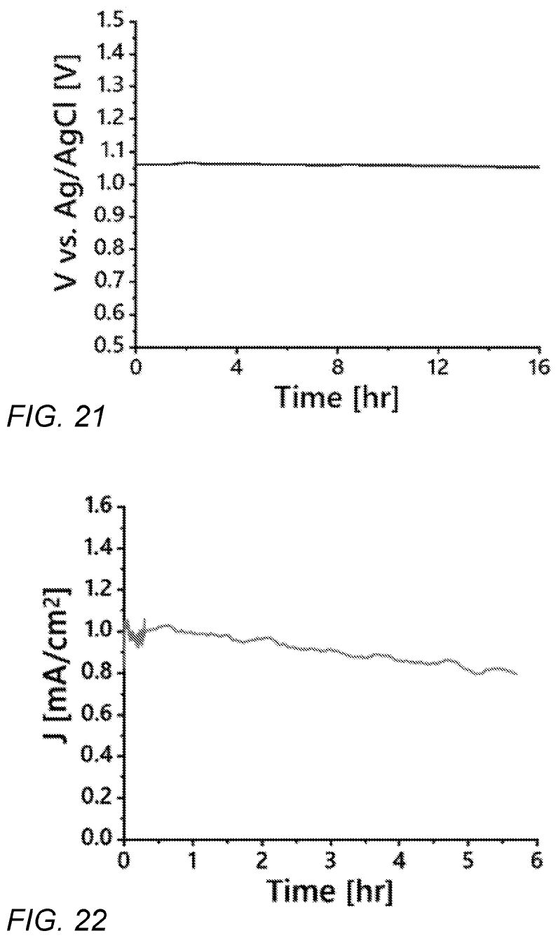

The bio-cathode and the BiVO₄/CoP photo-anode were coupled in a two-electrode cell configuration to construct a full photo-bio-electrochemical cell. In the two-electrode cell configuration the cathode side was enriched with oxygen. Glucose (40 mM) was dissolved in PB pH 7.3, 0.2M served as the cell solution in the anode side and the photo-anode was illuminated with white LED light. The measurements were performed at 37° C. with a scan rate of 2 mVs⁻¹. LSV measurements under oxygen saturated atmosphere and under air are presented in FIGS. 20A and 20B, respectively. Open-circuit voltage (OCV) potential during time and current under an applied potential of −0.3V vs. OCV during time of the full photo-bio-electrochemical cell are presented in FIGS. 21 and 22, respectively.

7. Conjugation of BiVO₄—CoP-HL with Pt Based Cathode for Photo-Electrochemical Cell Construction

As a control the BiVO₄—CoP-HL based photo-anode was coupled with Pt based cathode for cell construction. The photo-electrochemical cell performance was characterized by LSV and CA measurements; results are presented in FIG. 23 and FIG. 24, respectively. Measurements were performed at 37° C. in PB, 0.2M pH 7.3 while the cathode side was subjected to oxygen saturated conditions. The cell solution of the anode side was enriched with enriched with cellulose and enzymatic cellulase complex while the electrode was back illuminated with white LED light. The CA measurement was performed while a potential of −0.25V vs. OCV was applied.

### 8. Cellobiose Oxidation by the BiVO₄/CoP Base Photo-Anode

LSV measurements were then performed to evaluate whether the developed BiVO₄/CoP can oxidize cellobiose. Measurements were performed in PB pH 7.3, 0.2M without or with 40 mM of cellobiose in the cell solution while the photo-anode was illuminated with white LED light. LSV measurements are presented in FIG. 25A. Chronoamperometry measurement while 0V vs. Ag/AgCl was applied for 48 hours are presented in FIG. 25B.

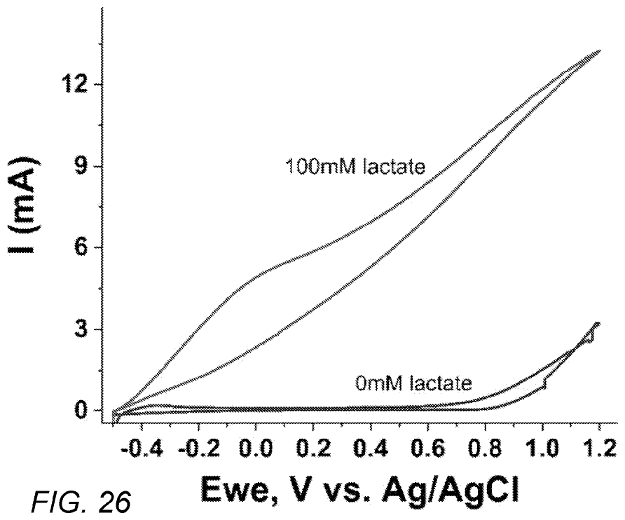

Polylactic acid (PLA) conversion to electricity-PLA is a common material for 3D printing, bags and more. PLA conversion to lactic acid can be achieved by enzymatic hydrolysis, and the lactic acid will be further utilized for electrical energy generation using photoanode oxidation. Microbial hydrolase such as proteinase K from Tritirachium album, or esterases ABO2449 from Alcanivorax borkumensis or RPA1511 from Rhodopseudomonas palustris can be used to enable biotic abiotic PLA conversion to electricity. LSV measurements were performed to evaluate whether the developed BiVO₄/COP can oxidize lactate. Measurements were performed in PB pH 7.3, 0.2M without or with 100 mM of lactate in the cell solution while the photo-anode was illuminated with white LED light. LSV measurement results are presented in FIG. 26. The results reveal that the developed BiVO₄/CoP can oxidize lactate with an onset potential of −0.5V vs. Ag/AgCl.

### Microbial Fuel Cell (MFC)

MFC utilizes microorganisms as catalysts for chemical energy conversion into electrical energy. The use of microbial fuel cells harbors several advantages over enzymatic-based fuel cells. First, enzyme isolation is expensive and time-consuming. Second, the use of MFCs provides a better model for real-world application as bacteria can serve as a biocatalyst for complex organic molecules degradation, and their conversion into electrical power and/or fuels. Clostridium Thermocellum is an anaerobic and thermophilic cellulolytic bacterium, known for its ability to efficiently degrade cellulose. This bacterium degrades cellulose to yield glucose, cellobiose, and cellodextrins as degradation products, which are further fermented to achieve ethanol. The bacterium can produce high yields of ethanol (25-30 g/liter). Thus, this bacterium is a promising candidate for biofuel production.

### Results

In this part we present the development of a microbial photo-electrochemical cell (MPEC) for biomass conversion into electrical energy and added-value chemicals. For the MPEC construction, the developed BiVO₄-HL-CoP-based photoanode was fabricated (HL=high loading). To improve the repeatability of the photoanode to suppress competitive reactions, i.e. water oxidation, the protocol for the photoanode preparation was further optimized. Thus, the charge passed through the electrode surface during the CoP electrodeposition step was limited to 0.38C/cm². The MPEC was then constructed while BiVO₄-HL-COP served as the working electrode, carbon as a counter, and Ag/AgCl as a reference electrode. The cell solution comprised PB pH 7.3, 0.2M while the cellulolytic bacteria Clostridium Thermocellum and cellulose were suspended in the solution. Cell assembly was performed inside an argon-sealed glove box to ensure the anaerobic conditions required for the bacteria. Before electrochemical measurements, the cell solution was incubated for 5 hours to enable cellulose degradation. The cell solution was maintained at 60° C. required for the bacteria's optimal activity throughout the measurement.

Chronoamperometry (CA) measurements under an applied voltage of 0V vs. Ag/AgCl indicated high photocurrent generation; however, the stability of the photoanode was limited, and a fast current drop was observed (Data not shown). That is likely due to the increase in the cell solution turbidity during the electrochemical measurements, which affects the light intensity streaming the electrode surface. Therefore, the bacteria and the cellulose were separated from the photo-anode by a polyethersulfone (PES) membrane, used as a physical barrier.

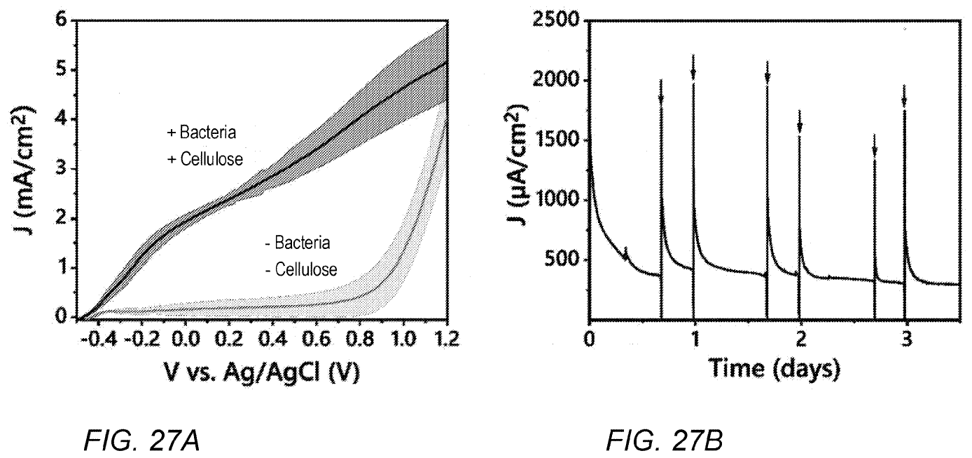

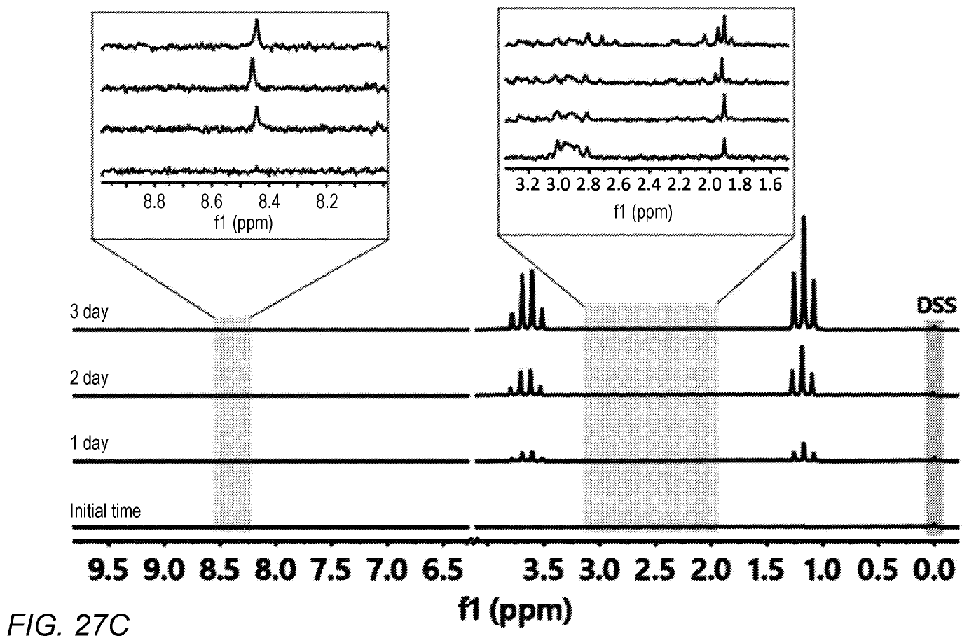

The cell was then constructed similarly except for the bacteria and the cellulose were separated by the PES membrane. After cell incubation for 5 hours, linear sweep voltammetry (LSV) measurement was performed to evaluate the cellulose degradation, the obtained products diffusion to the outer cell solution, and their oxidation by the photoanode. The LSV results presented in FIG. 27A indicated the oxidation of the cellulose degradation products. To assess the photoanode stability in this designed configuration, CA measurement was performed while the electrode was subjected to 0V vs. Ag/AgCl, under anaerobic conditions while the cell solution was maintained at 60° C. The results presented in FIG. 27B, indicate good photocurrent stability as the photocurrents were marinated at ~400 μA/cm² for at least 3 days. Samples taken from the cell solution during the CA test were analyzed via ¹H-NMR.

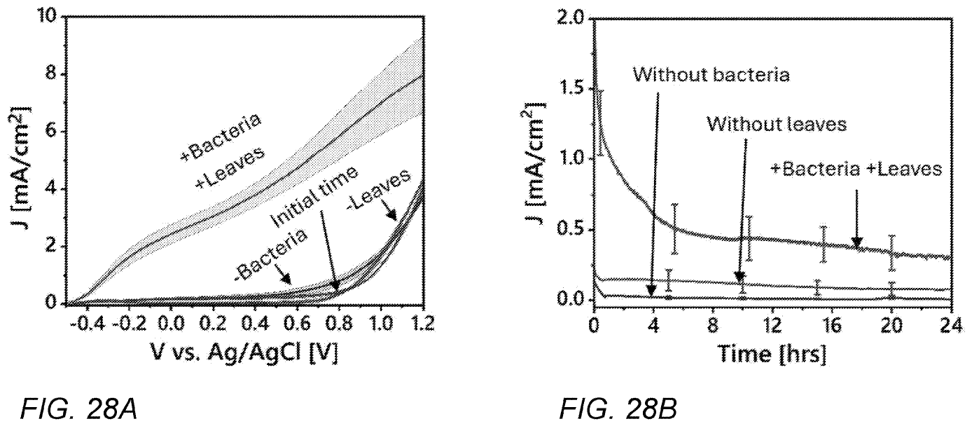

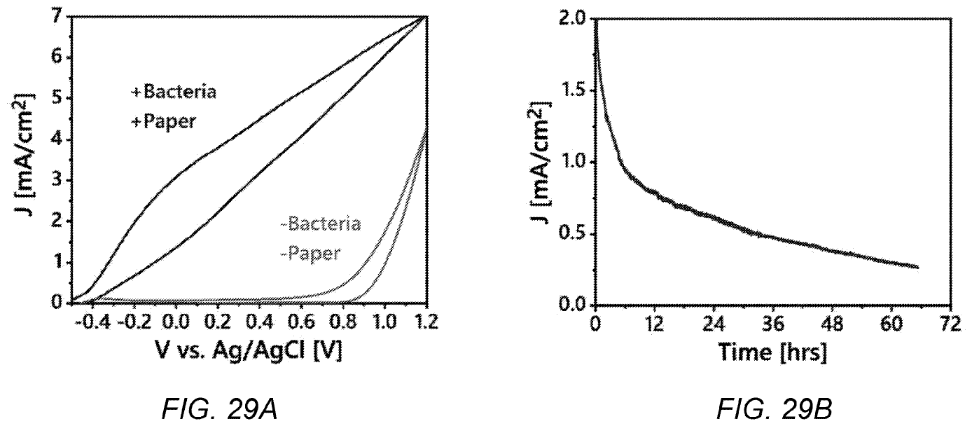

The results presented in FIG. 27C indicated triplet and quartet peaks, that can be attributed to ethanol ¹H-NMR spectrum. Additional peaks were observed in the ¹H-NMR spectra and further analysis should be performed to define their identity. Following these encouraging results, the MPEC was constructed similarly except for paper or fresh leaves were used as a substrate. The LSV results presented in FIG. 28A indicated that high photocurrents were observed after the 5-hour pre-incubation step, while fresh leaves served as a substrate for the cellulolytic bacteria. The onset potential for the oxidation reaction is −0.45V vs. Ag/AgCl, FIG. 28A. Control experiments lacking the leaves or the bacteria did not yield photocurrents, FIG. 28A. We therefore attributed the generated photocurrents to the oxidation of the leaf's degradation products. Chronoamperometry measurements indicated photocurrent generation for at least 24 hours, while the photocurrents generated as the control systems lacking the bacteria or the leaves indicated significantly lower photocurrent output, FIG. 28B. Additional experiments were performed with paper as a substrate for the cellulolytic bacteria. The results, presented in FIG. 29, indicate a similar trend as was observed with the leaves in the cell solution.

1.-40. (canceled)

41. A photo-electrochemical cell or system implementing a photoanode formed of or comprising an n-type material having a band gap below 2.5 eV and an oxidation potential of at least +1V vs. Ag/AgCl, when exposed to visible light irradiation; the n-type material being provided with an active coating and configured for generating photocurrents by oxidation of an organic material provided in an aqueous medium, without generating oxygen.

42. The cell according to claim 41, wherein the photoanode is a BiVO₄-based photoanode.

43. The cell according to claim 41, wherein the active coating is formed of a material being or comprising CoP or NiP or FeP or NiOₓ.

44. The cell according to claim 41, implementing a photocathode of a p-type material selected from p NiO, NiO/CdS, NiO/CdTe, NiO/CdSe, CuFeO₂/CuO, and CuₓO_{y}, wherein each of x and y is between 1 and 4.

45. The cell according to claim 41 configured as a water purification system or a wastewater treatment system.

46. The cell according to claim 41, comprising an electrode assembly comprising the photoanode and a photocathode and configured for receiving and holding the aqueous medium containing the organic material and an enzyme or a bacterium capable of generating said enzyme under anaerobic conditions.

47. The cell according to claim 41, wherein the organic material is a biomass.

48. The cell according to claim 41, wherein the organic material is or comprises cellulose.

49. The cell according to claim 46, wherein the enzyme is selected amongst lipases, amylases, cellulases, cellobiohydrolases, beta-glucosidases, lactases, hydrolases, lyases, ligases, and PETase.

50. The cell according to claim 46, wherein the enzyme is generated by bacterium selected from Clostridium, E. Coli, Bacillus, and Thermoacetica.

51. The cell according to claim 41, wherein the photoanode is provided in a cellulose-containing aqueous medium comprising an anaerobic bacterium generating an enzyme capable of degrading cellulose to glucose, wherein oxidation of the glucose on the photoanode generates photocurrents, with suppression of water oxidation.

52. A photo-electrochemical cell configured to hold an aqueous medium comprising cellulose and an enzyme capable of degrading said cellulose or an anaerobic bacterium selected to generate said enzyme, the cell being provided with an electrode assembly comprising a BiVO₄/CoP photoanode configured in said aqueous medium and exposed to solar (or visible light) radiation.

53. The cell according to claim 52, wherein the enzyme is a cellulase or wherein the bacterium generating the enzyme is a bacterium generating a cellulase.

54. The cell according to claim 41, wherein the aqueous medium is flown or mixed and maintained at a pH of between 7.1 and 7.6, and at a temperature between room temperature (23-33° C.) and 60° C.

55. The cell according to claim 41, the cell comprising a filter for preventing passivation of the photoanode.

56. The cell according to claim 55, wherein the filter is a polyethersulfone (PES) filter.

57. A process for generating photocurrents from an organic material provided in an aqueous medium, the process comprising treating an aqueous medium comprising the organic material and an enzyme or anaerobic bacteria generating said enzyme, in a system including an electrode assembly comprising a photoanode of an n-type material having a band gap below 2.5 eV and oxidation potential of at least +1V vs. Ag/AgCl, under conditions suitable for causing enzymatic decomposition of the organic material in said aqueous medium and oxidation of the decomposed material on the photoanode to generate the photocurrents.

58. The process according to claim 57, wherein the photoanode is a BiVO₄ electrode.

59. The process according to claim 57, for generating photocurrents from cellulose provided in the aqueous medium, the process comprising treating the aqueous medium comprising the cellulose and Clostridium Thermocellum, in a system including an electrode assembly comprising a BiVO₄/CoP, under conditions suitable for causing enzymatic decomposition of the cellulose in said aqueous medium into glucose and oxidation of the glucose on the photoanode to generate the photocurrents.

60. A process for generating photocurrents, the process comprising treating an aqueous medium comprising at least 300 nM cellulose and a cellulase enzyme or Clostridium Thermocellum, in a system including a BiVO₄/CoP photoanode, under light and applied potentials of between −0.5V and 0V vs. Ag/AgCl for causing decomposition of the cellulose in said aqueous medium and oxidation of the decomposed material on the photoanode to generate the photocurrents.
